(19) United States
(12) Patent Application Publication
(10) Pub. No.: US 2007/0093967 A1
(43) Pub. Date: Apr. 26, 2007

(54) Accessing data related to tissue coding

(75) Inventors: Edward K.Y. Jung, Bellevue, WA (US); Robert W. Lord, Seattle, WA (US); Lowell L. Wood JR., Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/516,689

(22) Filed: Sep. 5, 2006

Related U.S. Application Data
(63) Continuation-in-part of application No. 11/222,031, filed on Sep. 8, 2005.
(63) Continuation-in-part of application No. 11/286,133, filed on Nov. 23, 2005.
(63) Continuation-in-part of application No. 11/311,906, filed on Dec. 19, 2005.
(63) Continuation-in-part of application No. 11/314,730, filed on Dec. 21, 2005.
(63) Continuation-in-part of application No. 11/343,965, filed on Jan. 31, 2006.
(63) Continuation-in-part of application No. 11/347,804, filed on Feb. 3, 2006.
(63) Continuation-in-part of application No. 11/362,545, filed on Feb. 24, 2006.
(63) Continuation-in-part of application No. 11/471,289, filed on Jun. 19, 2006.
(63) Continuation-in-part of application No. 11/478,295, filed on Jun. 28, 2006.
(63) Continuation-in-part of application No. 11/503,501, filed on Aug. 11, 2006.

(51) Int. Cl. G06F 19/00

(52) U.S. Cl. 702/19

(57) ABSTRACT

An apparatus, device, methods, computer program product, and system are described that accept an identification of at least one instance of at least one treatment parameter, the at least one treatment parameter including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and that provide at least two instances of at least one treatment characteristic, the at least one treatment characteristic including at least one target-related tissue ancestry-correlated binding site.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Kunin, Benefit of Prior-Filed Application, USPTO Electronic Official Gazette, Mar. 18, 2003 at http://www.uspto.gov/web/offices/com/sol/og/2003/week11/patbene.htm. The present applicant entity has provided below a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

1. For purposes of the USPTO extra-statutory requirements, the present application constitutes a continuation in part of currently co-pending United States patent application entitled Data Techniques Related to Tissue Coding, naming Edward K. Y. Jung, Robert W. Lord, and Lowell L. Wood, Jr., as inventors, U.S. application Ser. No. 11/222,03 1, filed Sep. 8, 2005.
2. For purposes of the USPTO extra-statutory requirements, the present application constitutes a continuation in part of currently co-pending United States patent application entitled Data Techniques Related to Tissue Coding, naming Edward K. Y. Jung, Robert W. Lord, and Lowell L. Wood, Jr., as inventors, U.S. application Ser. No. 11/241,868, filed Sep. 30, 2005.
3. For purposes of the USPTO extra-statutory requirements, the present application constitutes a continuation in part of currently co-pending United States patent application entitled Accessing Data Related to Tissue Coding, naming Edward K. Y. Jung, Robert W. Lord, and Lowell L. Wood, Jr., as inventors, U.S. application Ser. No. 11/262,499, filed Oct. 28, 2005.

### TECHNICAL FIELD

This description relates to data handling techniques.

### SUMMARY

An embodiment provides a method. In one implementation, the method includes but is not limited to accepting an identification of at least one instance of at least one treatment parameter, the at least one treatment parameter including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. The method further includes providing at least two instances of at least one treatment characteristic, the at least one treatment characteristic including at least one target-related tissue ancestry-correlated binding site. In addition to the foregoing, other method aspects are described in the claims, drawings, and text forming a part of the present disclosure.

An embodiment provides a computer program product. In one implementation, the computer program product includes but is not limited to a signal-bearing medium bearing at least one of one or more instructions for accepting an identification of at least one instance of at least one treatment parameter, the at least one treatment parameter including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor and the signal bearing medium bearing one or more instructions for providing at least two instances of at least one treatment characteristic, the at least one treatment characteristic including at least one target-related tissue ancestry-correlated binding site. In addition to the foregoing, other computer program product aspects are described in the claims, drawings, and text forming a part of the present disclosure.

An embodiment provides a system. In one implementation, the system includes but is not limited to a computing device and instructions. The instructions when executed on the computing device cause the computing device to accept an identification of at least one instance of at least one treatment parameter, the at least one treatment parameter including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and to provide at least two instances of at least one treatment characteristic, the at least one treatment characteristic including at least one target-related tissue ancestry-correlated binding site. In addition to the foregoing, other system aspects are described in the claims, drawings, and text forming a part of the present disclosure.

An embodiment provides a device. In one implementation, the device includes but is not limited to a treatment system, the treatment system comprising treatment logic that is operable to accept an identification of at least one instance of at least one treatment parameter, the at least one treatment parameter including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor; and a treatment data memory that is operable to provide at least two instances of at least one treatment characteristic, the at least one treatment characteristic including at least one target-related tissue ancestry-correlated binding site. In addition to the foregoing, other device aspects are described in the claims, drawings, and text forming a part of the present disclosure.

An embodiment provides another method. In one implementation, the method includes but is not limited to accepting an identification of at least one instance of at least one treatment parameter, the at least one treatment parameter including at least one target-related tissue ancestry-correlated binding site, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. The method further includes providing at least two instances of at least one treatment characteristic, the at least one treatment characteristic including at least one target-related tissue ancestry-correlated binding agent. In addition to the foregoing, other method aspects are described in the claims, drawings, and text forming a part of the present disclosure.

In addition to the foregoing, various other embodiments are set forth and described in the text (e.g., claims and/or detailed description) and/or drawings of the present description.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices and/or processes described herein, as defined by the claims, will become apparent in the detailed description set forth herein.

### BRIEF DESCRIPTION OF THE DRAWINGS

FIG. 1 illustrates an example clinical system in which embodiments may be implemented, perhaps in a device.

FIG. 2 illustrates certain alternative embodiments of the clinical system of FIG. 1.

FIG. 3 illustrates an alternative embodiment of treatment data associated with the clinical system of FIG. 1.

FIG. 4 illustrates another alternative embodiment of treatment data associated with the clinical system of FIG. 1.

FIG. 5 illustrates another alternative embodiment of treatment data associated with the clinical system of FIG. 1, with specific examples of treatment data.

FIG. 6 illustrates additional alternative embodiments of treatment data associated with the clinical system of FIG. 1, with specific examples of treatment data.

FIG. 7 illustrates additional alternative embodiments of treatment data associated with the clinical system of FIG. 1, with specific examples of treatment data.

FIG. 8 illustrates an operational flow representing example operations related to accessing data related to tissue coding.

FIG. 9 illustrates an alternative embodiment of the example operational flow of FIG. 8.

FIG. 10 illustrates an alternative embodiment of the example operational flow of FIG. 8.

FIG. 11 illustrates an alternative embodiment of the example operational flow of FIG. 8.

FIG. 12 illustrates an alternative embodiment of the example operational flow of FIG. 8.

FIG. 13 illustrates an alternative embodiment of the example operational flow of FIG. 8.

FIG. 14 illustrates an alternative embodiment of the example operational flow of FIG. 8.

FIG. 15 illustrates an alternative embodiment of the example operational flow of FIG. 8.

FIG. 16 illustrates an alternative embodiment of the example operational flow of FIG. 8.

FIG. 17 illustrates an alternative embodiment of the example operational flow of FIG. 8.

FIG. 18 illustrates a partial view of an example computer program product that includes a computer program for executing a computer process on a computing device.

FIG. 19 illustrates an example device in which embodiments may be implemented.

FIG. 20 illustrates an operational flow representing example operations related to accessing data related to tissue coding.

FIG. 21 illustrates an alternative embodiment of the example operational flow of FIG. 20.

FIG. 22 illustrates an alternative embodiment of the example operational flow of FIG. 20.

The use of the same symbols in different drawings typically indicates similar or identical items.

### DETAILED DESCRIPTION

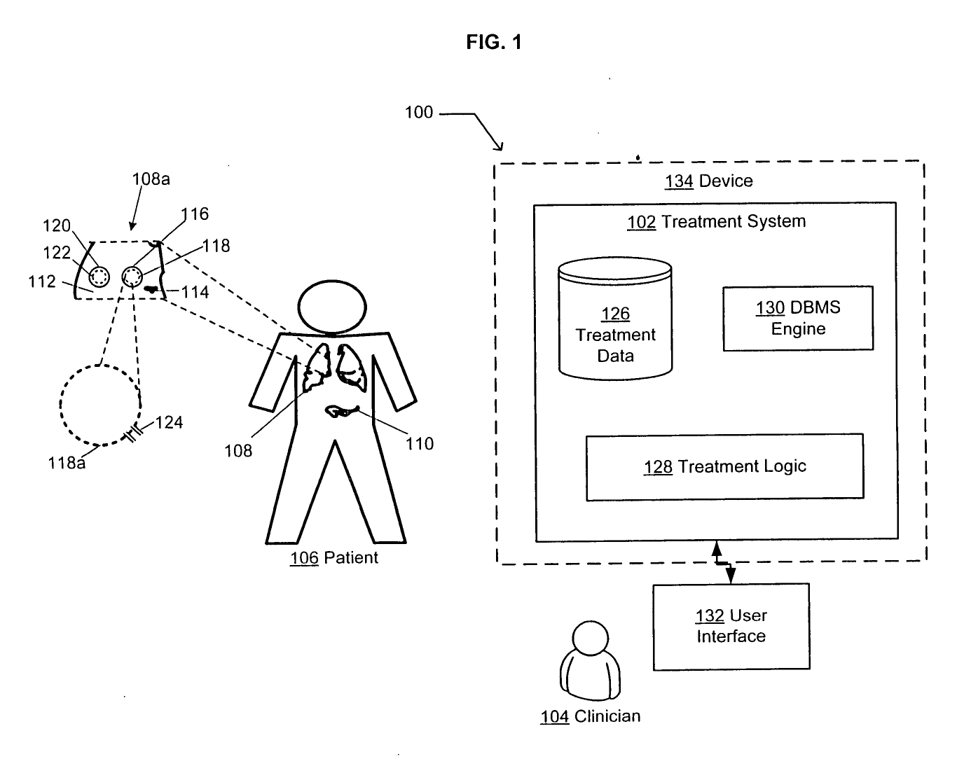

FIG. 1 illustrates an example clinical system 100 in which embodiments may be implemented. The clinical system 100 includes a treatment system 102. The treatment system 102 may be used, for example, to store, recall, access, process, implement, or otherwise use information that is beneficial in a clinical setting(s). For example, the treatment system 102 may be used to diagnose or treat patients by storing and/or providing information as to whether or how treatment agent(s) may be applied to a specific region(s) of interest of the human body, such as, for example, a lobe of the lungs, breast tissue, cancerous tissue at a certain bodily location, or other such regions of interest. As a further example, the treatment system 102 may provide information as to whether and/or how to minimize or avoid application of such treatment agents to regions of non-interest (for example, regions to which the treatment agent(s) should not be applied, in order to avoid, e.g., problematic side effects and other undesired results). On the basis of such clinical information, for example, targeted applications of treatment agents (e.g., medication, imaging agents, or other beneficial medical agents) may be carried out in a manner that achieves a desired outcome, while minimizing or eliminating unwanted applications to non-targeted bodily regions.

In FIG. 1, the treatment system 102 is used by a clinician 104. The clinician 104 may, for example, use the treatment system 102 to enter, store, request, or access clinical information such as, for example, the various examples provided herein. The clinician 104 may generally represent, for example, any person involved in health care, including, for example, a doctor, a nurse, a physician's assistant, or a medical researcher. The clinician 104 also may represent someone who is involved in health care in the sense of developing, managing, or implementing the treatment system 102, e.g., a software developer with clinical knowledge (or access to clinical knowledge), a database manager, or an information technologies specialist. Even more generally, some or all of various functions or aspects described herein with respect to the clinician 104 may be performed automatically, e.g., by an appropriately-designed and implemented computing device, or by software agents or other automated techniques.

A patient 106 generally represents any person with an illness, injury, or disease, or who is thought to potentially have such an illness, injury, or disease, or who may be wholly or partially healthy but who is nonetheless studied in order to determine information about such an illness, injury, or disease. The patient 106 also may represent or include other diagnostic and/or animal subjects that may be used in order, for example, to determine an efficacy of a particular medication or treatment, specific examples of which are provided herein. The patient 106 may represent a particular patient in a given clinical setting, such as in a doctor's office, or in a hospital, who is to be diagnosed and/or treated using the treatment system 102. The patient 106 also may represent the more abstract notion of a class of patients (e.g., patients having a certain age, gender, race, genetic makeup, or disposition to illness or disease), or, even more generally, may represent the general notion of a generic patient during basic research and/or development or application of various medical treatments or procedures. In this latter sense, the patient 106 may also represent a non-human animal (such as a primate) believed to be sufficiently similar to a human for the particular purposes that they may usefully substitute for such for the particular purposes.

As such, the patient 106 generally possesses or is associated with, for example, some or all of the various organs, systems, organ systems, organ subsystems, diseased tissue, and/or healthy tissue that may be found in the body. In FIG. 1, the patient 106 is illustrated as having a lung 108 and a pancreas 110, so that these (and other) body parts may be used as the bases for the specific examples given herein. Of course, many other applications of the treatment system 102 exist, over and above the examples provided herein.

In an exploded portion 108a of the lung 108, various example elements are illustrated, although not drawn to scale for the purposes of clarity and ease of illustration and description. For example, the lung 108 may include a healthy tissue portion 112, and a diseased tissue portion 114. The healthy tissue 112 may include, for example, healthy lung tissue, while the diseased tissue 114 may include, for example, a tumor or other cancerous tissue.

The lung 108 also may include a blood vessel 116, which is illustrated in a cut-away view, and which includes a tissue component 118 known as, by way of example nomenclature, the endothelium, endothelial layer, or endothelial cells. The endothelium or endothelial layer 118 generally refers to a layer of cells that lines an interior of a portion of the circulatory system, such as the blood vessel 116. In FIG. 1, the blood vessel 116 and the endothelial layer 118 are illustrated as being in the vicinity of the diseased tissue 114. In contrast, an example of a blood vessel 120 is illustrated that contains endothelial layer 122. The blood vessel 120 is shown as being in the vicinity of the healthy tissue 112 of the lung 108.

Certain properties of the endothelial layer 118 and the endothelial layer 122 may enable the targeted delivery of one or more treatment agents to a vicinity of the diseased tissue 114 and the healthy tissue 112, respectively. For example, blood (and other cells contained therein) will be transported within and along a length of the blood vessel 116, where the length of the blood vessel 116 naturally extends a relatively long distance in either direction toward/away from the diseased tissue 114. However, cells of the endothelial layer 118 that have developed and/or grown over a period of time in a vicinity of the diseased tissue 114 may exhibit characteristics that are unique, or essentially unique, to a site on the endothelial layer 118 in that particular vicinity.

For example, the diseased tissue 114 may include a tumor that has grown over a period of time. During that period of time, a corresponding growth or development of a site on the endothelial layer 118 may reflect, or otherwise be correlated with and/or affected by, the growth of the diseased tissue (tumor) 114. This correlation between the history or ancestry of the site on the endothelial layer 118 in the vicinity of the diseased tissue 114 may result in unique, or almost unique, properties of the tissue ancestry-correlated site, such as, for example, a display of specific and identifiable proteins. Moreover, similar comments may apply to a tissue ancestry-correlated site along the endothelial layer 122 of the blood vessel 120, in the vicinity of the healthy tissue 112. In this way, each such tissue ancestry-correlated site, whether in the lung or in other sites in the body, may be used to provide, effectively, a molecular-level address that specifies a location within the body, e.g., a location of the diseased tissue 114 and/or the healthy tissue 112.

Accordingly, such tissue ancestry-correlated sites may be used to direct treatment agents (such as, for example, medications, imaging agents, or radio-immunotherapy agents) in a desired fashion. For example, as described in more detail in certain examples provided herein, radionuclides may be applied to the diseased tissue 114.

In this regard, it should be understood that, without use of the tissue ancestry-correlated site(s) described herein, it may be difficult to direct such treatment agents to desired body regions with a necessary or desired level of precision. For example, many treatment agents may be delivered by injection (or by other delivery modalities, e.g., swallowing or absorption through the skin) into a bloodstream of the patient 106. However, without an effective way to direct the treatment agents once in the-bloodstream, a positive impact of the treatment agents may be reduced or eliminated. Moreover, ancillary delivery of the treatment agents to undesired regions (e.g., delivery of radionuclides to the healthy tissue 112 and/or to the pancreas 110 or other organs) may result in harm to the patient 106. Such harm may be particularly acute or problematic in cases where, for example, a concentration, dosage, or amount of the treatment agent in the bloodstream is required to be increased relative to an optimal treatment amount, simply to ensure that some portion of the treatment agent reaches and affects a desired end target. Similar comments may apply to other treatment modalities. For example, treatment of the diseased tissue 114 (e.g., a tumor) may be performed by radiation therapy in which the patient is exposed to radiation, and, again, the net effect of such treatment(s) may be negative due to harm caused by the radiation to the healthy tissue 112.

As just described, then, tissue ancestry-correlated sites may exist within and along the endothelial layers 118 and/or 122, in the vicinity of correlated tissues that may serve as target(s) (e.g., the diseased tissue 114) for certain treatment agent(s). For example, these target-related tissue ancestry-correlated sites may include, as described herein, certain proteins that may be known to bind to/with certain other agents. In one specific example discussed herein, a target-related tissue ancestry-correlated binding site includes a protein, aminopeptidase-P (APP), that is known to bind with an agent such as, for example, I-labeled monoclonal antibodies. If a treatment agent (such as, for example, radionuclides) is associated with the target-related tissue ancestry-correlated binding agent (e.g., the I-labeled monoclonal antibodies), then injection of the target-related tissue ancestry-correlated binding agent into the bloodstream will result in delivery of the treatment agent (e.g., radionuclides) to the target-related tissue ancestry-correlated binding site (e.g., APP in the vicinity of the lung 108). That is, as the target-related tissue ancestry-correlated binding agent moves through the bloodstream, the target-related tissue ancestry-correlated binding agent will bind with the target-related tissue ancestry-correlated binding site in the vicinity of the, in this example, diseased tissue 114, thus resulting in effective application of the attached treatment agent in the desired re-ion of the body of the patient 106.

In many cases, delivery of the treatment agent(s) to the vicinity of desired body regions, by delivering the treatment agents to defined sites along a blood vessel wall(s) in the desired vicinity, may be sufficient to obtain a desired result, even if the treatment agents are continually contained within the blood vessel(s) at the target-related tissue ancestry-correlated binding sites. In various cases, treatment agent delivery should occur with greater or lesser levels of specificity and/or efficacy. For example, in some cases, it may be sufficient to provide the treatment agent in the lung 108, while in other cases the treatment agent must or should be applied substantially only to the diseased tissue 114.

Additionally, in some cases, it may be possible and/or desirable to breach or penetrate a wall of the blood vessel(s) 116/120, in order to reach associated tissue(s) directly. For example, in FIG. 1, an enlarged view 11 8a of the endothelial layer 118 is illustrated that includes a mechanism by which the treatment agents may directly access a direct end target of tissue (e.g., the diseased tissue 114). Specifically, FIG. 1 illustrates a mechanism 124 that may include, for example, structures known as caveolae. Although the mechanism (e.g., caveolae) 124 are shown conceptually in FIG. 1 as tubes or access points, caveolae generally refer to small invaginations of a surface of the blood vessel 116 that carry out certain transport and/or signaling functions between cells within the blood vessel 116 and cells outside of the blood vessel 116 (e.g., the diseased tissue 114). Further discussion regarding caveolae 124 is provided in various examples, herein.

Although many other examples are provided herein and with reference to the various figures, it should be understood that many types and instances of treatment data may play a role in the use and application of the various concepts referenced above and described in more detail herein. The treatment system 102 may store such treatment data in a database 126 or other memory, for easy, convenient, and effective access by the clinician 104.

The treatment data 126 may include, for example, not only the target-related tissue ancestry-correlated binding site(s) and/or the related target-related tissue ancestry-correlated binding agent(s), but also various other parameters and/or characteristics related to treatment of the patient 106, examples of which are provided herein. Through detailed storage, organization, and use of the treatment data 126, the clinician 104 may be assisted in determining optimal treatment techniques for the patient 106, in order, for example, to select and deliver an appropriate type and/or level of a treatment agent, with an appropriate degree of accuracy, to a desired end target (based on an appropriate target-related tissue ancestry-correlated binding site and/or an appropriate target-related tissue ancestry-correlated binding agent), while minimizing any negative impact of such a selection/delivery, if any, on other regions of the body of the patient 106. Ordered assignment and/or storage of information within the treatment data 126, as described herein, facilitates and/or enables such recall, access, and/or use of the treatment data by the clinician 104 in treating the patient 106.

In the treatment system 102, treatment logic 128 may be used to store, organize, access, recall, or otherwise use the information stored in the treatment data 126. For example, the treatment logic 128 may access a database management system (DBMS) engine 130, which may be operable to perform computing operations to insert or modify new data into/within the treatment data 126, perhaps in response to new research or findings, or in response to a preference of the clinician 104. For example, if a new treatment agent is discovered to be effective on the diseased tissue 114, the clinician 104 may access the treatment system 102 using a user interface 132, in order to use the DBMS engine 130 to associate the new treatment agent with one or more instances of the target-related tissue ancestry-correlated binding site(s) and/or target related tissue ancestry-correlated binding agent(s) that may be known to be useful in targeting the diseased tissue 114, within the treatment data database 126 (assuming that the treatment agent is suitable for direct or indirect delivery via the target-related tissue ancestry-correlated binding agent, as described herein). As another example, if a new target-related tissue ancestry-correlated binding site is identified in the endothelial layer 118 in the vicinity of the diseased tissue 114, then this new target-related tissue ancestry-correlated binding site may be associated with one or more instances of a target-related tissue ancestry-correlated binding agent, e.g., there may be more than one agent that is useful in attaching to the new target-related tissue ancestry-correlated binding site for delivery of one or more treatment agents.

Similarly, in a case where the clinician 104 seeks, for example, to diagnose or treat the patient 106, the clinician 104 may access the user interface 132 to use the treatment logic 128 and/or the DBMS Engine 130 to determine best known methods or treatments to be applied in a given clinical scenario. For example, if the patient 106 has a certain type of disease or illness in a certain region of the body, then the clinician may input this information via the user interface 132 in order to obtain one or more options for treating the disease or illness. For example, if the patient 106 exhibits the diseased tissue 114, then the clinician 104 may select the (type of) diseased tissue 114 in the lung 108 as an end target, and the treatment logic 128 may then interface with the DBMIS engine 130 to obtain, from the treatment data 126, one or more options for providing the treatment agent to the diseased tissue 114, e.g., one or more target-related tissue ancestry-correlated binding sites (such as, for example, two different proteins that are expressed or displayed in the endothelial layer 118 in the vicinity of the diseased tissue 114). As another example, if the clinician 104 is already aware of a target-related tissue ancestry-correlated binding site in the vicinity of the diseased tissue 114, then the clinician 104 may input this information into the treatment system 102 and be provided with one or more, for example, target-related tissue ancestry-correlated binding agents that may be known to attach to the known target-related tissue ancestry-correlated binding site.

In this regard, it should be understood that multiple instances of a target-related tissue ancestry-correlated binding site, as described, may be present at any one location in the body, and, moreover, virtually any region or site in the body having a blood-tissue interface may also exhibit an associated, target-related tissue ancestry-correlated binding site. Further, new instances of target-related tissue ancestry-correlated binding sites may be discovered and/or approved for clinical use on a relatively frequent basis. Still further, there may be many different treatment parameters and/or characteristics that may be related to the various target-related tissue ancestry-correlated binding site(s) and/or target-related tissue ancestry-correlated binding agent(s), such as, for example, treatment agents and/or delivery mechanisms.

As a result, the clinician 104, e.g., a physician in the field, may not be aware of all currently-available content of the treatment data 126. Thus, the treatment system 102 provides the clinician with readily-available, accurate, current, and/or comprehensive treatment information, and also provides techniques to ensure that the treatment information remains accurate, current, and/or comprehensive, by allowing the addition and/or modification of the existing treatment data 126, as new treatment information becomes available.

In FIG. 1, the treatment system 102 is illustrated as possibly being included within a device 134. The device 134 may include, for example, a mobile computing device, such as a personal digital assistant (PDA), or a laptop computer. Of course, virtually any other computing device may be used to implement the treatment system 102, such as, for example, a workstation, a desktop computer, or a tablet PC.

Additionally, not all of the treatment system 102 need be implemented on a single computing device. For example, the treatment data 126 may be stored on a remote computer, while the user interface 132 and/or treatment logic 128 are implemented on a local computer. Further, aspects of the treatment system 102 may be implemented in different combinations and implementations than that shown in FIG. 1. For example, functionality of the DBMS engine 130 may be incorporated into the treatment logic 128 and/or the treatment data 126.

The treatment data 126 may be stored in virtually any type of memory that is able to store and/or provide access to information in, for example, a one-to-many, many-to-one, and/or many-to-many relationship. Such a memory may include, for example, a relational database and/or an object-oriented database, examples of which are provided in more detail herein.

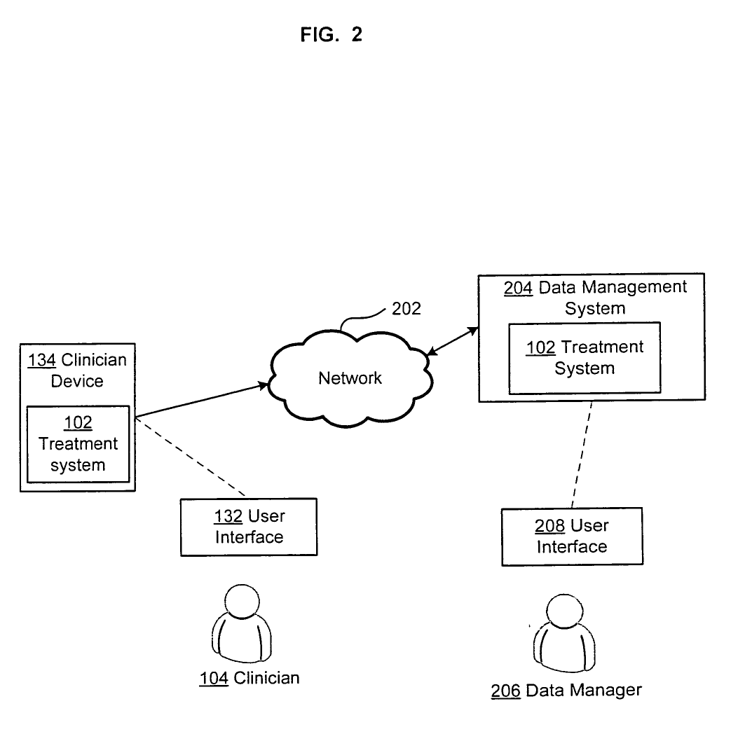

FIG. 2 illustrates certain alternative embodiments of the clinical system 100 of FIG. 1. In FIG. 2, the clinician 104 uses the user interface 132 to interact with the treatment system 102 deployed on the clinician device 134. The clinician device 134 is in communication over a network 202 with a data management system 204, which is also running the treatment system 102; the data management system 204 may be interacted with by a data manager 206 through a user interface 208. Of course, it should be understood that there may be many clinicians other then the specifically-illustrated clinician 104, each with access to an individual implementation of the treatment system 102. Similarly, multiple data management systems 204 may be implemented.

In this way, the clinician 104, who may be operating in the field, e.g., in an office and/or hospital environment, may be relieved of a responsibility to update or manage contents in the treatment data 126, or other aspects of the treatment system 102. For example, the data management system 204 may be a centralized system that manages a central database of the treatment data 126, and/or that deploys or supplies updated information from such a central database to the clinician device 134.

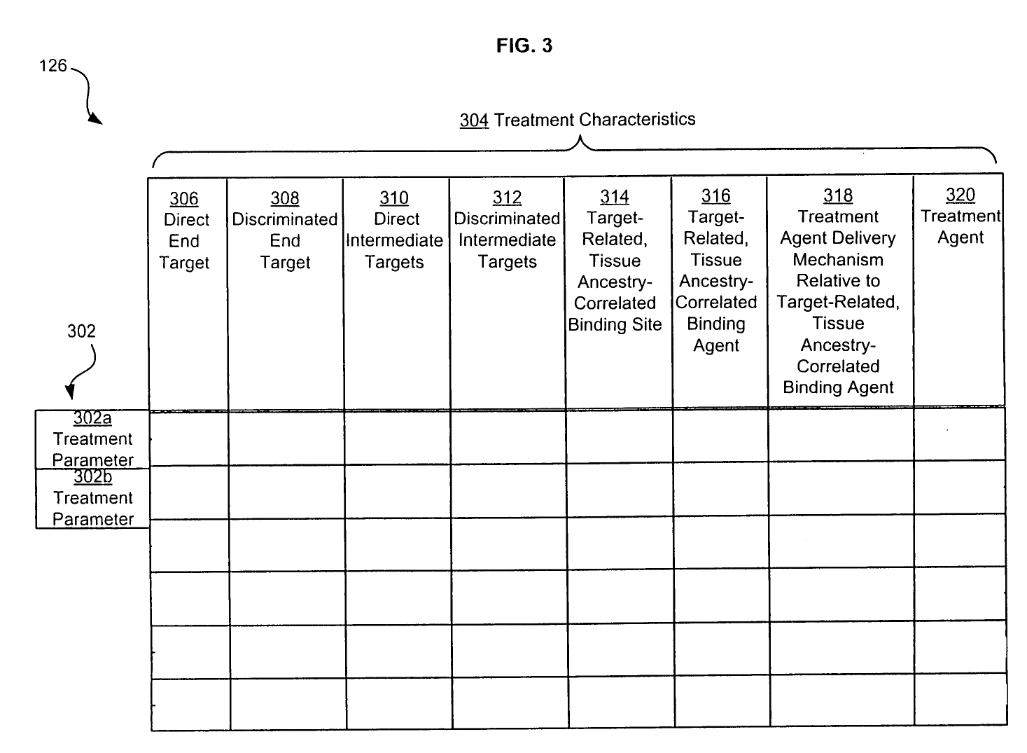

FIG. 3 illustrates an alternative embodiment of the treatment data 126 associated with the clinical system 100 of FIG. 1. In FIG. 3, and in the various examples herein, a particular nomenclature is used for the terms described above and related terms, in order to provide consistency and clarity of description. However, it should be understood that other terminology may be used to refer to the same or similar concepts.

In FIG. 3, treatment parameters 302 are stored and organized with respect to a plurality of treatment characteristics 304. The treatment characteristics 304 include many of the terms and concepts just described, as well as additional, but not exhaustive, terms and concepts that may be relevant to a use and operation of the treatment system 102.

For example, the treatment characteristics 304 include a direct end target 306. The direct end target 306 may refer, for example, to any tissue, organ, organ system, organ subsystem (or type thereof), or any other body part or region that may be targeted for healing, destruction, repair, enhancement, and/or imaging that may be targeted—directly or indirectly—via an associated target-related tissue ancestry-correlated binding site 314 and/or an associated tissue related tissue ancestry-correlated binding agent 316 and/or an associated treatment agent delivery mechanism relative to the target-related tissue ancestry-correlated binding agent 318 and/or an associated treatment agent 320. A discriminated end target 308 refers to targets that should be avoided during implementation of the healing, destruction, repair, enhancement and/or imaging actions that may be discriminated—directly or indirectly—via an associated target-related tissue ancestry-correlated binding site 314 and/or an associated tissue related tissue ancestry-correlated binding agent 316 and/or an associated treatment agent delivery mechanism relative to the target-related tissue ancestry-correlated binding agent 318 and/or an associated treatment agent 320. For example, in FIG. 1, the lung 108 may include the direct end target 306 as the diseased tissue 114, and may include the discriminated end target 308 as the healthy tissue 112, and/or the pancreas 110.

Somewhat analogously, a direct intermediate target 310 refers to targets that are connected to, associated with, or in the vicinity of the direct end target that may be targeted via an associated target-related tissue ancestry-correlated binding site 314 and/or an associated tissue related tissue ancestry-correlated binding agent 316 and/or an associated treatment agent delivery mechanism relative to the target-related tissue ancestry-correlated binding agent 318 and/or an associated treatment agent 320. For example, a portion of the endothelial layer 118 in a vicinity of the diseased tissue 114 (or other end target) may act as a direct intermediate target 310. Then, a discriminated intermediate target 312 may refer to endothelial tissue of the layer 118 that is not in a vicinity of the diseased tissue 114 that may be discriminated via an associated target-related tissue ancestry-correlated binding site 314 and/or an associated tissue related tissue ancestry-correlated binding agent 316 and/or an associated treatment agent delivery mechanism relative to the target-related tissue ancestry-correlated binding agent 318 and/or an associated treatment agent 320.

As already referenced, a target-related tissue ancestry-correlated binding site 314 refers to a determined chemical and/or genetic and/or biological structure to which various chemical compounds and/or genes may be affixed. For example, the target-related tissue ancestry-correlated binding site 314 may include a specific protein that is displayed at the endothelial layer 118 in a vicinity of the diseased tissue 114. The target-related tissue ancestry-correlated binding site 314 may be selectively associated with the direct end target 306 either directly or through the direct intermediate target 310.

A target-related tissue ancestry-correlated binding agent 316, then, may refer to some specific chemical and/or genetic and/or biological structure that more or less selectively binds or attaches to a related one of the target-related tissue ancestry-correlated binding sites 314. The target-related tissue ancestry-correlated binding agent 316 also may be associated with a treatment agent delivery mechanism relative to the target-related tissue ancestry-correlated binding agent 318, which may refer either to something that may be directly attached to (or associated with) the target-related tissue ancestry-correlated binding agent 316, and/or something that may be attached to (or associated with) one or more intermediary or indirect structures that attach to the target-related tissue ancestry-correlated binding agent 316 and that act to house and/or deliver a treatment agent 320. As an example of the intermediary or indirect structures just referenced, a nano-container may be used that dissolves and/or otherwise opens in a vicinity of the target-related tissue ancestry-correlated binding site 314, and thereby releases and/or delivers the treatment agent 320 included inside.

The treatment agent 320 thus binds/attaches to, or otherwise is associated with, either directly or indirectly, the target-related tissue ancestry-correlated binding agent 316. Thus, as described, the treatment agent 320 may be effectively transported to the appropriate direct intermediate target 310 and thereby to the target-related tissue ancestry-correlated binding site 314. In this way, the treatment agent 320 may be delivered to the direct end target 306 (or at least to a vicinity of the direct end target 306), while not being delivered either to the discriminated intermediate target(s) 312 and/or the discriminated end target(s) 308.

FIG. 3 thus illustrates that there may be many different relationships or associations between any one (or more) of the treatment characteristics 304. For example, one or more instances of any one or more of the treatment characteristics 304 may be considered to be one of the treatment parameters 302, and thereafter associated with one or more instances of the remaining treatment characteristics 304. For example, the direct end target 306 may be considered to be the treatment parameter(s) 302, where a first instance 302a of the direct end target 306 may refer to diseased lung tissue, and the second instance 302b may refer to diseased breast tissue, and both instances may be associated with an instance of the target-related tissue ancestry-correlated binding agent 316. Similarly, two or more instances of the target-related tissue ancestry-correlated binding agent 316 (e.g., I-labeled APP monoclonal antibodies targeted on two different antigens) may be associated with one treatment agent 320 (e.g., radio-immunotherapy via application of low levels of radionuclides).

Many other examples of relationships and associations between the various treatment parameters 302 and/or the treatment characteristics 304 (and/or other treatment information) may be defined or determined and stored in the treatment data 126 according to the treatment logic 128. Certain of these examples are provided herein.

Additionally, although the treatment data 126 is illustrated conceptually in FIG. 3 as a flat table in which one or more of the selected treatment parameters 302 are associated with one or more of the treatment characteristics, it should be understood that this illustration is for explanation and example only, and is not intended to be limiting in any way with respect to the various ways in which the treatment data 126 may be stored, organized, accessed, recalled, or otherwise used.

For example, the treatment data 126 may be organized into one or more relational databases. In this case, for example, the treatment data 126 may be stored in one or more tables, and the tables may be joined and/or cross-referenced in order to allow efficient access to the information contained therein. Thus, the treatment parameter(s) 302 may define a record of the database(s) that is associated with various ones of the treatment characteristics 304.

In such cases, the various tables may be normalized so as, for example, to reduce or eliminate data anomalies. For example, the tables may be normalized to avoid update anomalies (in which the same information would need to be changed in multiple records, and which may be particularly problematic when treatment data database 126 is large), deletion anomalies (in which deletion of a desired field or datum necessarily but undesirably results in deletion of a related datum), and/or insertion anomalies (in which insertion of a row in a table creates an inconsistency with another row(s)). During normalization, an overall schema of the database may be analyzed to determine issues such as, for example, the various anomalies just referenced, and then the schema is decomposed into smaller, related schemas that do not have such anomalies or other faults. Such normalization processes may be dependent on, for example, desired schema(s) or relations between the treatment parameters 302 and/or treatment characteristics 304, and/or on desired uses of the treatment data 126.

Uniqueness of any one record in a relational database holding the treatment data 126 may be ensured by providing or selecting a column of each table that has a unique value within the relational database as a whole. Such unique values may be known as primary keys. These primary keys serve not only as the basis for ensuring uniqueness of each row (e.g., treatment parameter) in the database, but also as the basis for relating or associating the various tables within one another. In the latter regard, when a field in one of the relational tables matches a primary key in another relational table, then the field may be referred to a foreign key, and such a foreign key may be used to match, join, or otherwise associate (aspects of) the two or more related tables.

FIG. 3 and associated potential relational databases represent only one example of how the treatment data may be stored, organized, processed, accessed, recalled, and/or otherwise used.

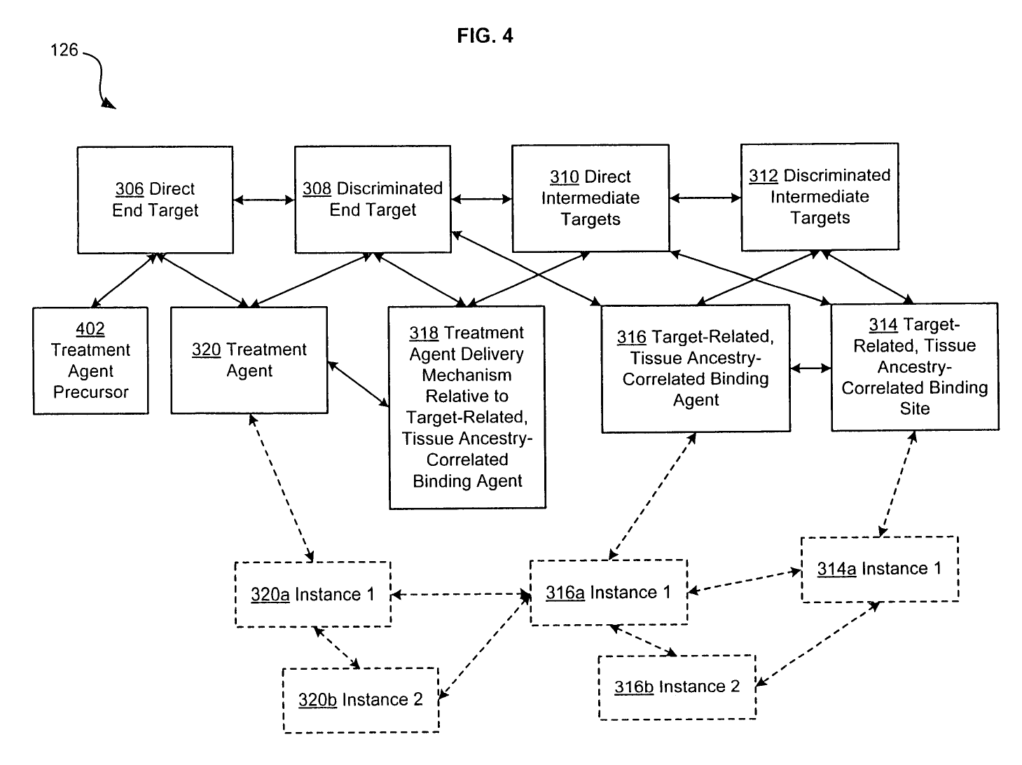

FIG. 4 illustrates another alternative embodiment of treatment data 126 associated with the clinical system 100 of FIG. 1, in which the treatment data 126 is conceptually illustrated as being stored in an object-oriented database.

In such an object-oriented database, the various treatment parameter(s) 302 and/or treatment characteristic(s) 304, and/or instances thereof, may be related to one another using, for example, links or pointers to one another. FIG. 4 illustrates a conceptualization of such a database structure in which the various types of treatment data are interconnected, and is not necessarily intended to represent an actual implementation of an organization of the treatment data 126.

The concepts described above may be implemented in the context of the object-oriented database of FIG. 4. For example, two instances 320a and 320b of the treatment agent 320 may be associated with one (or more) instance 316a of the target-related tissue ancestry-correlated binding agent 316. Meanwhile, two instances 316a and 316b of the target-related tissue ancestry-correlated binding agent 316 may be associated with an instance 314a of the target-related tissue ancestry-correlated binding site 314.

Also, other data may be included in the treatment data 126. For example, in FIG. 4, a treatment agent precursor 402 is shown that refers generally to an agent used to facilitate application of the treatment agent 320, e.g., an immune-response element that is used to identify/mark/bond with the target-related tissue ancestry-correlated binding site 314 and/or a substance that when metabolized becomes treatment agent 320, such as with prodrugs.

Many other examples of databases and database structures also may be used. Other such examples include hierarchical models (in which data are organized in a tree and/or parent-child node structure), network models (based on set theory, and in which multi-parent structures per child node are supported), or object/relational models (combining the relational model with the object-oriented model).

Still other examples include various types of extensible Mark-up Language (XML) databases. For example, a database may be included that holds data in some format other than XML, but that is associated with an XML interface for accessing the database using XML. As another example, a database may store XYML data directly. Additionally, or alternatively, virtually any semi-structured database may be used, so that context may be provided to/associated with stored data elements (either encoded with the data elements, or encoded externally to the data elements), so that data storage and/or access may be facilitated.

Such databases, and/or other memory storage techniques, may be written and/or implemented using various programming or coding languages. For example, object-oriented database management systems may be written in programming languages such as, for example, C++ or Java. Relational and/or object/relational models may make use of database languages, such as, for example, the structured query language (SQL), which may be used, for example, for interactive queries for information and/or for gathering and/or compiling data from the relational database(s).

As referenced herein, the treatment system 102 may be used to perform various data querying and/or recall techniques with respect to the treatment data 126, in order to facilitate treatment and/or diagnosis of the patient 106. For example, where the treatment data are organized, keyed to, and/or otherwise accessible using one or more of the treatment parameters 302 and/or treatment characteristics 304, various Boolean, statistical, and/or semi-Boolean searching techniques may be performed.

For example, SQL or SQL-like operations over one or more of the treatment parameters 302/treatment characteristics 304 may be performed, or Boolean operations using the treatment parameters 302/treatment characteristics 304 may be performed. For example, weighted Boolean operations may be performed in which different weights or priorities are assigned to one or more of the treatment parameters 302/treatment characteristics 304, perhaps relative to one another. For example, a number-weighted, exclusive-OR operation may be performed to request specific weightings of desired (or undesired) treatment data to be included (excluded).

For example, the clinician 104 may wish to determine examples of the direct end target 306 that are associated with examples of the discriminated end target 308 that are highly discriminated against with respect to delivery of the target-related tissue ancestry-correlated binding agent 316, for highly-specific delivery of the treatment agent 320. For example, the clinician 104 may want to know instances of the treatment agent 320 that may be delivered to the lungs as the direct end target 306, without substantially affecting the pancreas, liver, or other tissue, organ, or organ system/subsystem. In other examples, the clinician may be willing to tolerate lower levels of discrimination (e.g., increased delivery of the treatment agent 320 to other body regions), perhaps because the patient 106 is in an advanced stage of illness. As another example, the clinician 104 may start with a preferred (type of) the treatment agent 320., and may request from the treatment system 102 various delivery techniques (e.g., target-related tissue ancestry-correlated binding agent 316) that may be available, perhaps with varying levels of efficacy.

The clinician 104 may specify such factors using, for example, the user interface 132. For example, the clinician 104 may be able to designate one or more of the treatment parameters 302/treatment characteristics 304, and assign a weight or importance thereto, using, for example, a provided ranking system. In this regard, and as referenced herein, it should be understood that the clinician 104 may wish to deliver a particular instance of the treatment agent 320, e.g., a particular radionuclide to be delivered to a tumor. However, such a treatment agent, if applied by conventional techniques, may be problematic or prohibited (e.g., where a current physiological condition of the patient 106 and/or state of an immune system of the patient 106 is insufficient to allow the clinician 104 to use the desired treatment agent). Moreover, the clinician 104 may not be aware that a suitable target-related tissue ancestry-correlated binding site 314 and/or target-related tissue ancestry-correlated binding agent 316 has (have) been discovered for delivering the treatment agent with a desired/required level of accuracy. However, the clinician 104 may query the treatment system 102 based on the desired treatment agent 320, and may thereby discover the technique(s) by which the treatment agent may be applied, and with the necessary level of specificity.

Similarly, data analysis techniques (e.g., data searching) may be performed using the treatment data 126, perhaps over a large number of databases. For example, the clinician 104 may perform a physical screening of the patient 106, and may input some body system, tissue, organ, or organ system/subsystem parameters against which screening is to be performed. Then, the clinician should receive a listing of target-related tissue ancestry-correlated binding sites and/or target-related tissue ancestry-correlated binding agents that are ranked according to some criteria. For example, the clinician 104 may receive a listing of instances of the target-related tissue ancestry-correlated binding site 314 that provide a particularly high or low level of discrimination with respect to a particular direct end target 306, discriminated end target 308, and/or treatment agent 320. In this way, for example, if the patient 106 has an organ or organ subsystem that requires protection from a given instance of the treatment agent 320, then the clinician 104 may select an instance of the target-related tissue ancestry-correlated binding site 314 and/or of the target-related tissue ancestry-correlated binding agent 316 accordingly, even if some relative sacrifice of binding strength/accuracy is associated with such a selection.

By way of further example, other parameters/characteristics may be factored in. For example, elimination pathways may be tracked, databased, and/or weighted for use in the treatment data 126 and/or the treatment system 102. For example, if a particular instance of the target-related tissue ancestry-correlated binding agent is especially readily eliminated by the liver, then, in a case where the patient 106 has impaired hepatic function, such an instance may be selected for delivering the treatment agent 320, even if an otherwise superior instance of the target-related tissue ancestry-correlated binding agent 316 is known. Algorithms implementing such query/recall/access/searching techniques may thus use Boolean or other techniques to output, for example, a thresholded, rank-ordered list. The treatment logic 128 may then assign a key or other identifier to such a list(s), for easier use thereof the next time a like query is performed.

Design and testing of querying techniques in particular implementations of the treatment system 102 may involve, for example, entry of candidate treatment parameters 302/treatment characteristics 304 (or instances thereof) into a database(s), along with associated test results and/or affinity metrics that may be used to determine/weight targets or sets of targets. Then, an identifier may be generated that is unique to the target(s) set(s).

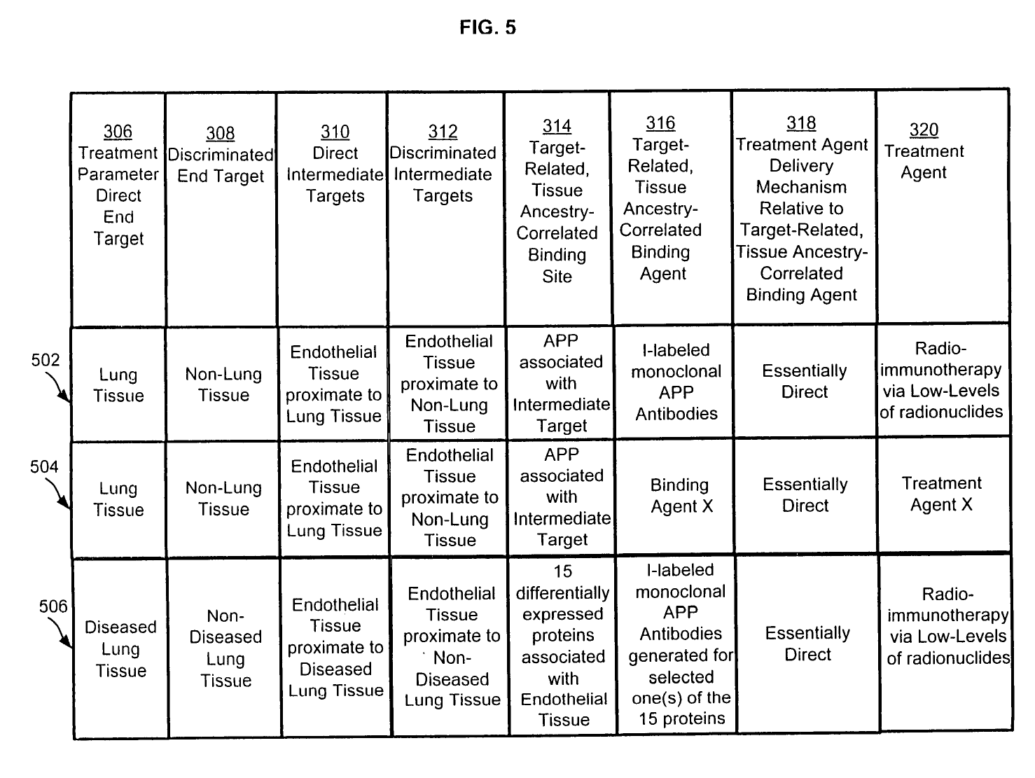

Still other examples/applications include avoiding an auto-immune response of the patient 106, in order to achieve a desired result. For example, the treatment system 102 may be used to determine/catalog/use treatment data that relates to treatment parameters 302/treatment characteristics 304 that are known or suspected to avoid self-epitopes (i.e., those unlikely to generate an undesired autoimmune response). FIG. 5 illustrates another alternative embodiment of treatment data associated with the clinical system 100 of FIG. 1, with specific examples of treatment data. In particular, all of FIGS. 5-7 provide or refer to example results from related technical papers, which are specifically referenced below.

For example, the first and second rows of the table of FIG. 5 (e.g., rows 502, 504, and 506, respectively) refer to examples that may be found in Oh, P. et al., “Subtractive Proteomic Mapping of the Endothelial Surface in Lung and Solid Tumours for Tissue-Specific Therapy,” Nature, vol. 429, pp. 629-635 (Jun. 10, 2004), which is hereby incorporated by reference in its entirety, and which may be referred to herein as the Oh reference.

In the Oh reference, it is generally disclosed that regions of endothelium may change or alter over time, based on what tissues are in the vicinity thereof, as referenced herein. The Oh reference, for example, identified lung-induced and/or lung-specific endothelial cell surface proteins based on a hypothesis that a surrounding tissue (micro) environment of the endothelial cell surface proteins modulates protein expression in the vascular endothelium. The Oh reference identified specific proteins that were found to be expressed at an endothelial surface by specifying two regions of interest (e.g., a “lung region” and a “non-lung region”), and then determining proteins within the two regions. Then, by subtracting the two sets of proteins from one another, non-common proteins were identified.

In this way, uniquely occurring proteins at a specific endothelial site (e.g., the target-related tissue ancestry-correlated binding site 314 at a specific direct intermediate target 310) were identified. Then, these uniquely-occurring proteins were used as targets for generated antibodies. As a result, it was possible to target, for example, lung-specific tissues as opposed to non-lung-specific tissues, and/or to target tumors as opposed to non-tumor tissues. More specifically, for example, it was determined to be possible to target tumor-induced endothelial cell proteins (e.g., target-related tissue ancestry-correlated binding sites 314) for delivery thereto of drugs, imaging agents, and/or radiation agents (e.g., treatment agents 320) that were attached to appropriate antibodies (target-related tissue ancestry-correlated binding agents 316).

Thus, to set forth specific examples, a row 502 illustrates an example in which the direct end target 306 includes a treatment parameter of “lung tissue.” In this example, the discriminated end target 308 includes “non-lung tissue.” The direct intermediate target 310 includes endothelial tissues that are proximate to the lung tissue, while the discriminated intermediate target 312 includes endothelial tissue that is proximate to the non-lung tissue.

The target-related tissue ancestry-correlated binding site 314 in this example includes aminopeptidase-P (APP), which is a protein that was detected substantially only in endothelial plasma membranes from the lung tissue (e.g., direct end target 306). In order to take advantage of the immuno-accessibility of APP in vivo, I-labeled monoclonal antibodies were used as the target-related tissue ancestry-correlated binding agent 316, and were intravenously injected into test rats. Subsequent imaging of the lungs illustrated rapid and specific targeting of APP antibody to the lung (e.g., direct end target 306), with significantly reduced accumulation of the injected dose at non-lung tissue (e.g., the discriminated end target 308). Thus, by selecting the treatment agent 320 to include radio-immunotherapy via low levels of radionuclides (e.g., 100 μCi of I¹²⁵), a treatment agent delivery mechanism relative to target-related tissue ancestry-correlated binding agent 318 may involve essentially direct delivery, in that the radionuclide(s) may be affixed to the I-labeled monoclonal APP antibodies. Further, although the term antibody is used herein in various examples, it should be understood that other immuno-reactive features of the adaptive immune system also may be used in a similar or analogous manner, including entities that serve to mediate antibody generation, such as, for example, helper T cells or dendritic cells.

In the row 504 of FIG. 5, a conceptual secondary example drawn from/based on the Oh reference is included, in order to illustrate various concepts described herein, e.g., with respect to FIGS. 1-4. Specifically, in the row 504, various ones of the treatment parameters and/or treatment characteristics are the same as in the row 502, except that a second example of the target-related tissue ancestry-correlated binding agent 316 is illustrated generically as “Binding Agent X,” and, similarly, a second example of a generically-referenced treatment agent 320 is illustrated as “Treatment Agent X.” As such, the row 504 illustrates, for example, that two separate instances of the target-related tissue ancestry-correlated binding agent 316 and/or the treatment agent 320 may be associated with, e.g., an instance of either the direct end target 306, and/or with an instance of the target-related tissue ancestry-correlated binding site 314.

The row 506 illustrates another example from the Oh reference. In the row 506, the direct end target 306 is illustrated as “diseased lung tissue,” while the discriminated end target 308 is illustrated as “non-diseased lung tissue.” Thus, the direct intermediate target 310 is illustrated as “endothelial tissue proximate to the diseased lung tissue,” while the discriminated intermediate target 312 is illustrated as “endothelial tissue that is proximate to non-diseased lung tissue.”

Then, the target-related tissue ancestry-correlated binding site 314 is illustrated as Fifteen differentially-expressed proteins (e.g., expressed according to the subtractive techniques described herein) associated with the direct intermediate target 310, e.g., the endothelial tissue proximate to the diseased lung tissue. As a result, the target-related tissue ancestry-correlated binding agent 316 is selected and illustrated as I-labeled monoclonal APP antibodies that may be generated for one or more of the fifteen differentially-expressed proteins. As in the row 502, the treatment agent delivery mechanism relative to target-related tissue ancestry-correlated binding agent 318 may involve essentially direct attachment of the treatment agent 320 that is illustrated as radio-immunotherapy via low-levels of radionuclides. In this way, such radionuclides may be concentrated in, and may thereby destroy, tumors. In particular, for example, an identified tumor target was the 34 KDa protein recognized by annexin A1 (AnnA1) antibodies, which was significantly present in substantially only in tumor endothelial plasma membrane.

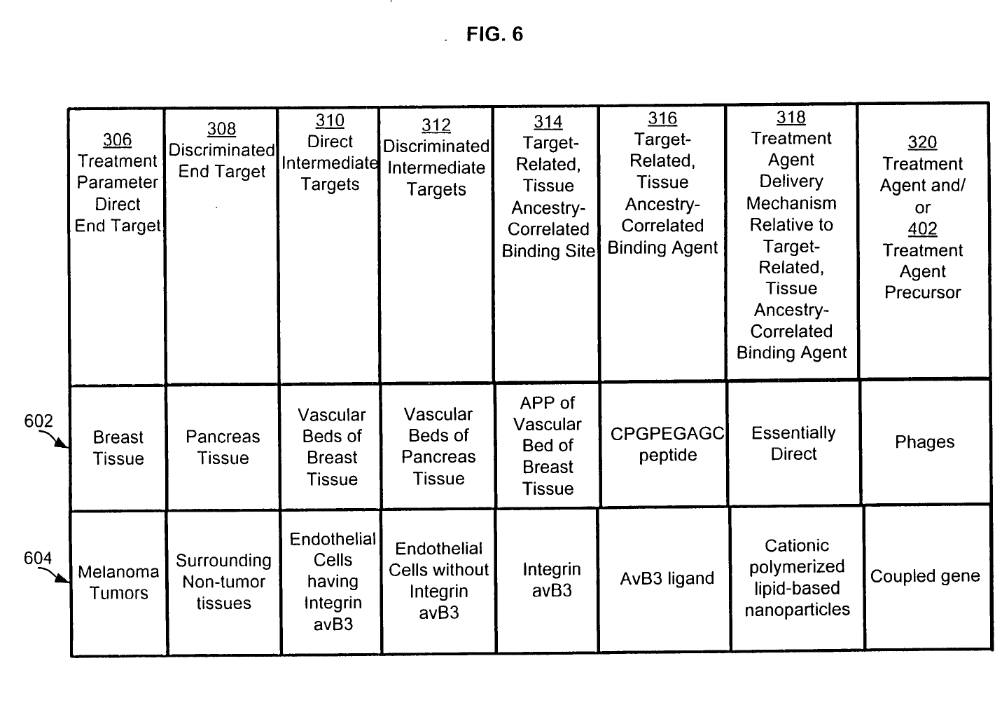

FIG. 6 illustrates additional alternative embodiments of treatment data associated with the clinical system 100 of FIG. 1, with specific examples of treatment data. In FIG. 6, a row 602 illustrates examples that may be found in Essler et al., “Molecular Specialization of Breast Vasculature: A Breast-Homing Phage-Displayed Peptide Binds to Aminopeptidase P in Breast Vasculature,” Proceedings of the National Academy of Sciences, vol. 99, No. 4, pp. 2252-2257 (Feb. 19, 2002), which is hereby incorporated by reference in its entirety, and which may be referred to herein as the Essler reference.

In the Essler reference, a plurality of peptides (e.g., two or more amino acids joined together via a peptide bond) having a general structure of CX7C (where C is cysteine and X is any amino acid) I-labeled monoclonal antibodies were injected into mice. Then tissues of interest were observed to determine a presence of phage(s), and thereby to determine which peptide of the plurality of peptides honed in on the observed tissue(s). In this way, it was determined that the CPGPEGAGC peptide was useful in providing a homing point for phages of the patient's immune system, and, in particular, was useful as a binding agent for the breast tissue, while not binding to pancreas tissue. Although these specific examples of peptides are provided for illustration and explanation, it should be understood that the term peptide as used herein may refer to virtually any lineal peptide-bonded string of amino acid residues, which include various structures thereof, unless context dictates otherwise. For example, a lipopeptide may be interpreted to include virtually all lipoproteins, while glycopeptides may include virtually all glycoproteins.

Thus, in the row 602, the direct end target 306 is illustrated as breast tissue, while the discriminated end target 308 is illustrated as pancreas tissue. The direct intermediate target 310 is illustrated as vascular beds of breast tissue, while the discriminated intermediate target 312 is illustrated as vascular beds of pancreas tissue.

The target-related tissue ancestry-correlated binding site 314 includes a protein, aminopeptidase-P (APP), of the vascular bed of breast tissue. The target-related tissue ancestry-correlated binding agent 316 includes a cyclic nonapeptide known as the CPGPEGAGC peptide, which is shown in the Essler paper to home to the aminopeptidase P receptor. The treatment agent precursor 402 is shown to include phages, which were essentially directly delivered via the CPGPEGAGC peptide to the APP of the vascular bed of breast tissue, and which facilitate attachment of additional/alternative treatment agents 320 to the APP.

A row 604 of FIG. 6 illustrates an example from Hood et al., “Tumor Regression by Targeted Gene Delivery to the Neovasculature,” Science, vol. 296, pp. 2404-2407 (Jun. 28, 2002), which is incorporated by reference in its entirety and which is referred to herein as the Hood reference. The Hood reference refers to the molecule integrin avB3, that plays a role in endothelial cell survival during formation of new blood vessels in a given region, and is preferentially expressed therein. A cationic polymerized lipid-based nanoparticle was synthesized and covalently coupled to a small organic avB3 ligand; that is, the ligand was demonstrated to serve as a binding agent for the integrin avB3 that is preferentially expressed in endothelial cells.

Accordingly, in the row 604, melanoma tumors were used as the direct end target 306, while the discriminated end target 308 is shown as surrounding non-tumor tissues. The direct intermediate target 310 is illustrated as endothelial cells having integrin avB3, while the discriminated intermediate target 312 is shown as endothelial cells without integrin avB3. Thus, the target-related tissue ancestry-correlated binding site 314 is shown to include the integrin avB3, while the target-related tissue ancestry-correlated binding agent 316 is shown to include the avB3 ligand that attaches to the integrin avB3. The treatment agent 320 included a gene selected to disrupt formation of new blood vessels in the tumor(s), which was delivered using the cationic polymerized lipid-based nanoparticle(s), and which thereby deprived the tumor(s) of blood and destroyed the tumor(s).

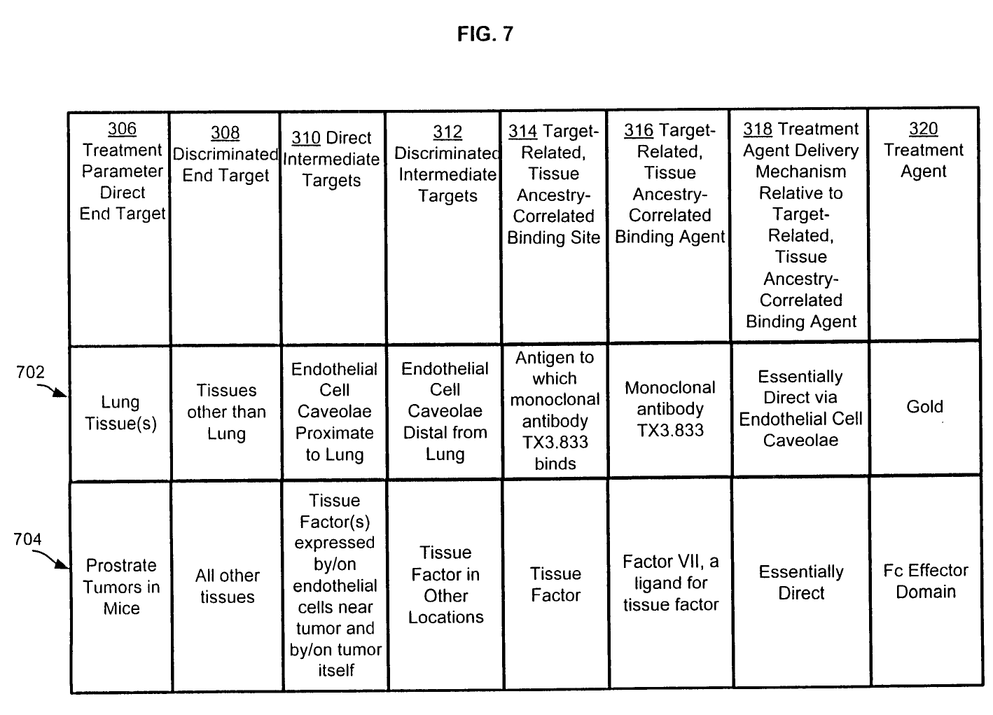

FIG. 7 illustrates additional embodiments of treatment data associated with the clinical system 100 of FIG. 1, with specific examples of treatment data. In a row 702, an example is illustrated from McIntosh et al., “Targeting Endothelium and Its Dynamic Caveolae for Tissue-Specific Transcytosis in vivo: A Pathway to Overcome Cell Barriers to Drug and Gene Delivery,” Proceedings of the National Academy of Sciences, vol. 99, no. 4, pp. 1996-2001 (Feb. 19, 2002), which is hereby incorporated by reference and which may be referred to herein as the McIntosh reference. In the McIntosh reference, endothelial cell plasma membranes from the lungs were analyzed to determine monoclonal antibodies targeted thereto. Additionally, the McIntosh reference illustrated use of the caveolae 124 to allow the treatment agent 320 to cross the endothelium and be delivered directly to lung tissue.

Thus, in the row 702, the direct end target 306 is shown as lung tissue, while the discriminated end target 308 is shown as non-lung tissue. The direct intermediate target 310 is shown as endothelial cell caveolae proximate to the lung tissue, while the discriminated intermediate target 312 is shown as endothelial cell caveolae that is distal from the lung tissue.

The target-related tissue ancestry-correlated binding site 314 is shown as a determined/selected antigen to which the monoclonal antibody TX3.833 binds, so that the target-related tissue ancestry-correlated binding agent 316 is shown as the monoclonal antibody TX3.833 itself. In this way, the treatment agent 320 of gold affixed directly to the TX3.833 antibody was transported over the endothelial plasma membrane into the tissues of interest (e.g., lung tissues); in other words, the caveolae 124 was used to conduct transcytosis.

A row 704 illustrates an example from Zhiwei et al., “Targeting Tissue Factor on Tumor Vascular Endothelial Cells and Tumor Cells for Immunotherapy in Mouse Models of Prostatic Cancer,” Proceedings of the National Academy of Sciences, vol. 98, no. 21, pp. 12180-12185 (Oct. 9, 2001), which is hereby incorporated by reference in its entirety, and which may be referred to as the Zhiwei reference. In the Zhiwei reference, a “tissue factor” is identified as a transmembrane receptor that forms a strong and specific complex with an associated ligand, factor VII (fVII). Such tissue factor, although not normally expressed on endothelial cells, may be expressed on tumor endothelial cells of the tumor vasculature.

Thus, in the example of the row 704, the direct end target 306 includes prostrate tumors, while the discriminated end target 308 includes all other tissues. The direct intermediate target 310 includes tissue factor(s) expressed by/on endothelial cells near the tumor(s) and by/on the tumor itself. The target-related tissue ancestry-correlated binding site 314 includes the tissue factor, while the target-related tissue ancestry-correlated binding site agent 316 includes the factor VII (fVII), the ligand for the tissue factor. In this way, the direct treatment agent 320 of an Fc effector domain was used to provide a marker for an induced immune response.

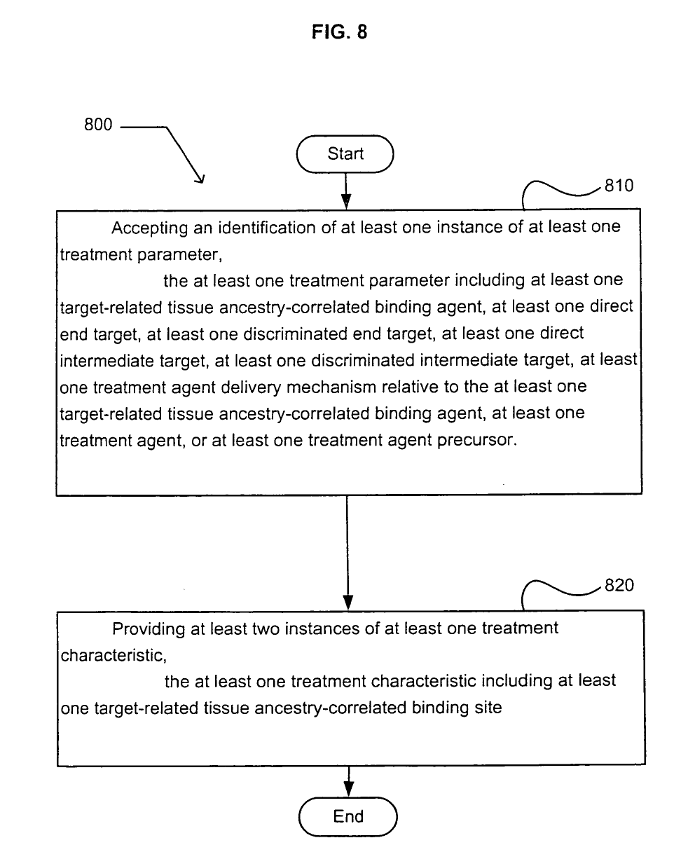

FIG. 8 illustrates an operational flow 800 representing example operations related to data techniques for tissue coding. In FIG. 8 and in following figures that include various examples of operational flows, discussion and explanation may be provided with respect to the above-described examples of FIGS. 1-7, and/or with respect to other examples and contexts. However, it should be understood that the operational flows may be executed in a number of other environment and contexts, and/or in modified versions of FIGS. 1-7. Also, although the various operational flows are presented in the sequence(s) illustrated, it should be understood that the various operations may be performed in other orders than those which are illustrated, or may be performed concurrently.

After a start operation, the operational flow 800 moves to an accepting operation 810 where an identification of at least one instance of at least one treatment parameter is accepted. The at least one treatment parameter may include at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor.

For example, the treatment logic 128 of the treatment system 102 may accept an identification of at least one instance of the target-related tissue ancestry-correlated binding agent 316, such as, for example, at least one instance of appropriate binding I-labeled monoclonal antibodies, which may be received, for example, by way of the user interface 132. For example, the clinician 104 may enter a name of the at least one instance of the target-related tissue ancestry-correlated binding agent 316, or may select one or more instances from a list provided by the treatment logic 128. Of course, one or more other instances of the treatment parameters recited in the operation 810 may be accepted, such as, for example, one or more radionuclides that are accepted as instances of the treatment agent 320.

Then, in a providing operation 820, at least two instances of at least one treatment characteristics are provided. The at least one treatment characteristic may include at least one target-related tissue ancestry-correlated binding site. For example, the at least one treatment characteristic may include one or more of the target-related tissue ancestry-correlated binding site 314, such as, for example, one or more of the fifteen differentially-expressed proteins referenced in the row 506 of FIG. 5. The at least one treatment characteristic may be provided, for example, by way of the user interface 132. For example, the treatment logic 128 may provide a name of at least one instance of the target-related tissue ancestry-correlated binding site 314, or may provide the clinician 104 with a list of one or more such instances.

In this regard, it should be understood that the accepting operation 810 and/or the providing operation 820 may be performed with respect to a digital representation (e.g., as digital data) of the at least one treatment parameter and/or the at least two treatment characteristics. For example, the treatment logic 128 may accept a digital or analog (for conversion into digital) representation of the at least one treatment parameter, for presentation to the DBMS engine 130 and/or the treatment data 126. As another example, the treatment logic 128 may provide a digitally-encoded representation of the at least two treatment characteristics from the treatment data 126, where the treatment data 126 may be implemented and accessed locally, and/or may be implemented and accessed remotely.

Thus, an operation(s) may be performed related either to a local or remote storage of the digital data, or to another type of transmission of the digital data. As discussed herein, in addition to accessing, querying, recalling, or otherwise obtaining the digital data for the providing operation, operations may be performed related to storing, assigning, associating, or otherwise archiving the digital data to a memory, including, for example, sending and/or receiving a transmission of the digital data from a remote memory. Accordingly, any such operation(s) may involve elements including at least an operator (e.g., either human or computer) directing the operation, a transmitting computer, and/or a receiving computer, and should be understood to occur within the United States as long as at least one of these elements resides in the United States.

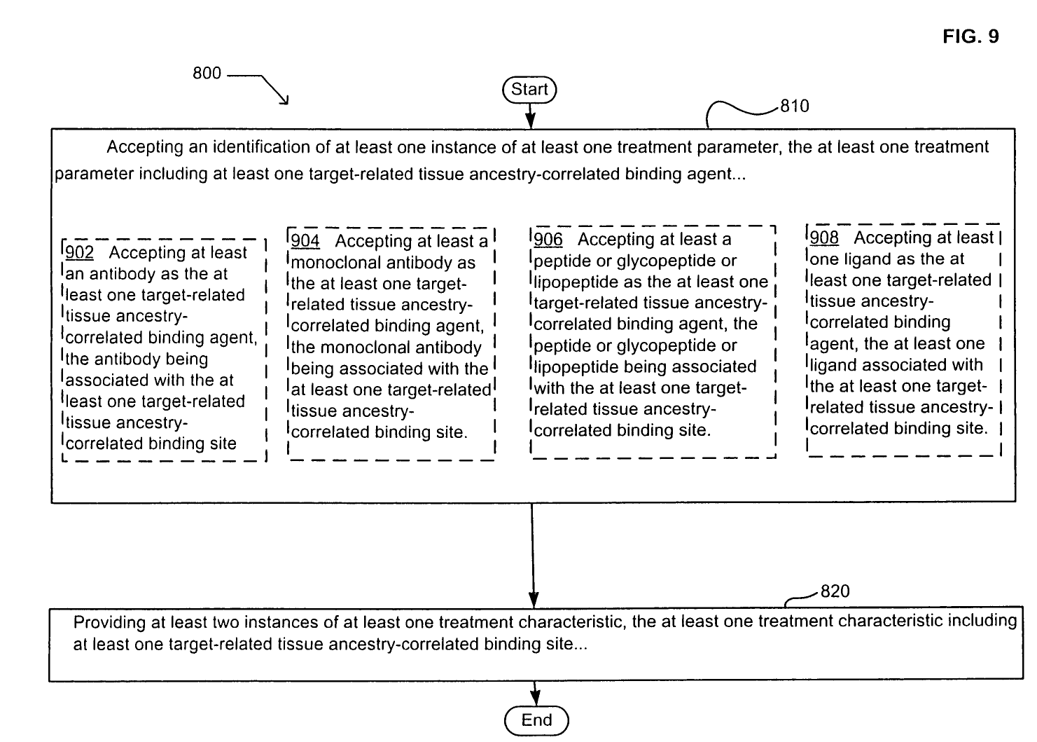

FIG. 9 illustrates alternative embodiments of the example operational flow 800 of FIG. 8. FIG. 9 illustrates example embodiments where the accepting operation 810 may include at least one additional operation. Additional operations may include operation 902, operation 904, operation 906, or operation 908.

At the operation 902, at least an antibody is accepted as the at least one target-related tissue ancestry-correlated binding agent, the antibody being associated with the at least one target-related tissue ancestry-correlated binding site. For example, as shown in rows 502, 504, and 506 of FIG. 5, and as shown in the row 702 of FIG. 7, various types of antibodies may be accepted by the treatment logic 128 as instance(s) of the target-related tissue ancestry-correlated binding agent 316, e.g., from the clinician 104 seeking corresponding instances of the target-related tissue ancestry-correlated binding site 314 (e.g., APP and/or antigen), as obtained by the treatment logic 128 from the treatment data 126.

At the operation 904, at least a monoclonal antibody may be accepted as the at least one target-related tissue ancestry-correlated binding agent, the monoclonal antibody being associated with the at least one target-related tissue ancestry-correlated binding site. For example, as again shown in rows 502, 504, and 506 of FIG. 5, and as shown in the row 702 of FIG. 7, various types of I-labeled monoclonal antibodies may be appropriately accepted by the treatment logic 128 as instances of the target-related tissue ancestry-correlated binding agent 316 that are stored in association with corresponding instance(s) of the target-related tissue ancestry-correlated binding site 314 within the treatment data 126 of the treatment system 102. In this way, the (monoclonal) antibodies may be used to target the corresponding target-related tissue ancestry-correlated binding site(s), for delivery of a desired instance of the treatment agent 320, as described herein.

At the operation 906, at least a peptide or glycopeptide or lipopeptide may be accepted as the at least one target-related tissue ancestry-correlated binding agent, the peptide or glycopeptide or lipopeptide being associated with the at least one target-related tissue ancestry-correlated binding site. For example, as shown in the row 602 of FIG. 6, the treatment logic 128 may accept the CPGPEGAGC peptide as the target-related tissue ancestry-correlated binding agent 316, where the CPGPEGAGC is known (e.g., from an association stored in the treatment data 126) to bind to a target-related tissue ancestry-correlated binding site such as APP, e.g., the APP of vascular bed(s) of breast tissue.

At the operation 908, at least one ligand may be accepted as the at least one target-related tissue ancestry-correlated binding agent, the at least one ligand being associated with the at least one target-related tissue ancestry-correlated binding site. For example, as shown in the row 704 of FIG. 7, the ligand fVII may be accepted by the treatment logic 128 as the target-related tissue ancestry-correlated binding agent 316, which may be stored in the treatment data 126 in association with the target-related tissue ancestry-correlated binding site 314 of tissue factor.

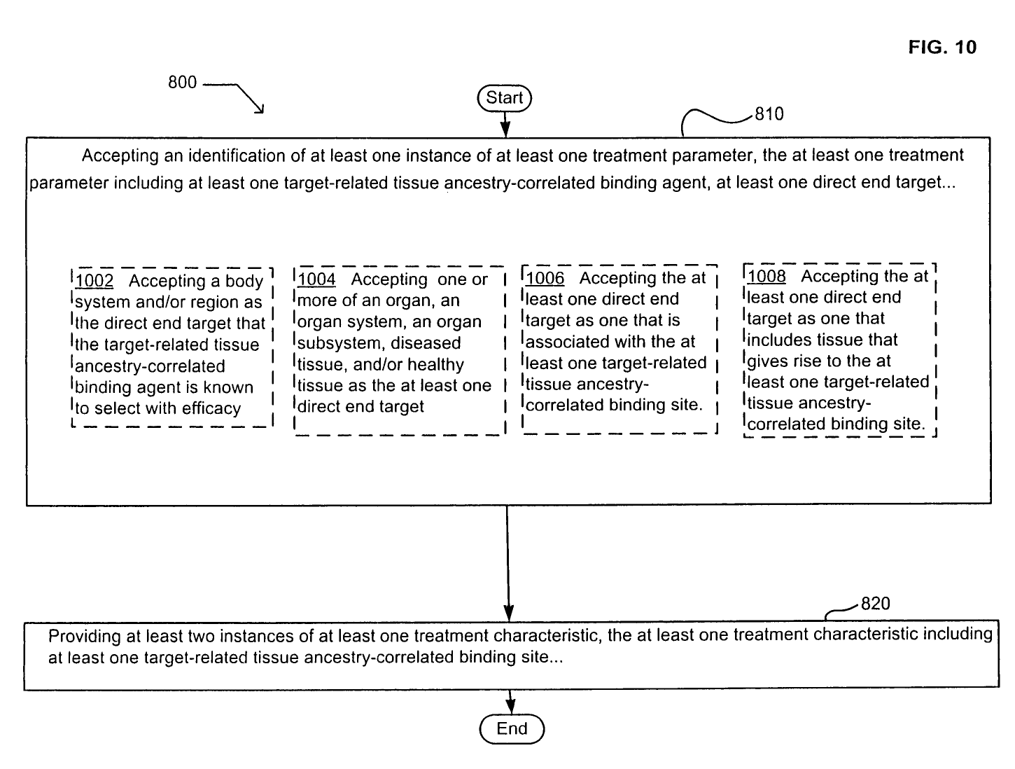

FIG. 10 illustrates alternative embodiments of the example operational flow 800 of FIG. 8. FIG. 10 illustrates example embodiments where the accepting operation 810 may include at least one additional operation. Additional operations may include operation 1002, operation 1004, operation 1006, and/or operation 1008.

At the operation 1002, a body system and/or region may be accepted as the direct end target that the target-related tissue ancestry-correlated binding agent is known to select with efficacy. For example, the treatment logic 128 may accept (e.g., from the clinician 104) information about the cardiovascular system, the digestive system, the respiratory system, and/or regions associated therewith, or other body systems/regions, as the direct end target 306.

At the operation 1004, one or more of an organ, an organ system, an organ subsystem, diseased tissue, and/or healthy tissue may be accepted as the at least one direct end target. For example, the treatment logic 128 may accept (e.g., by way of the user interface 132) information about the lungs, liver, pancreas, or other organ, or breast or other tissue, as the direct end target 306. Additionally, diseased tissue in these or other organs, e.g., tumors or other cancerous cells, or healthy tissues, e.g., adipose tissue, also may be accepted as the direct end target 306.

At the operation 1006, the at least one direct end target may be accepted as one that is associated with the at least one target-related tissue ancestry-correlated binding site. For example, the direct end target 306, in an example instance, may be accepted by the treatment logic 128 as including lung tissue from the lung 108, and may be associated with APP (or other protein) that is associated with endothelial tissue 118 within the blood vessel 116 in the treatment data 126.

At the operation 1008, the at least one direct end target may be accepted as one that includes tissue that gives rise to the at least one target-related tissue ancestry-correlated binding site. For example, as shown in the row 602 of FIG. 6, the direct end target 306 of (a vascular bed of) breast tissue may be accepted by the treatment logic 128 by virtue of giving rise to associated endothelial tissue within a blood vessel of the breast tissue, on which APP or other protein may develop that is specific to the endothelial tissue.

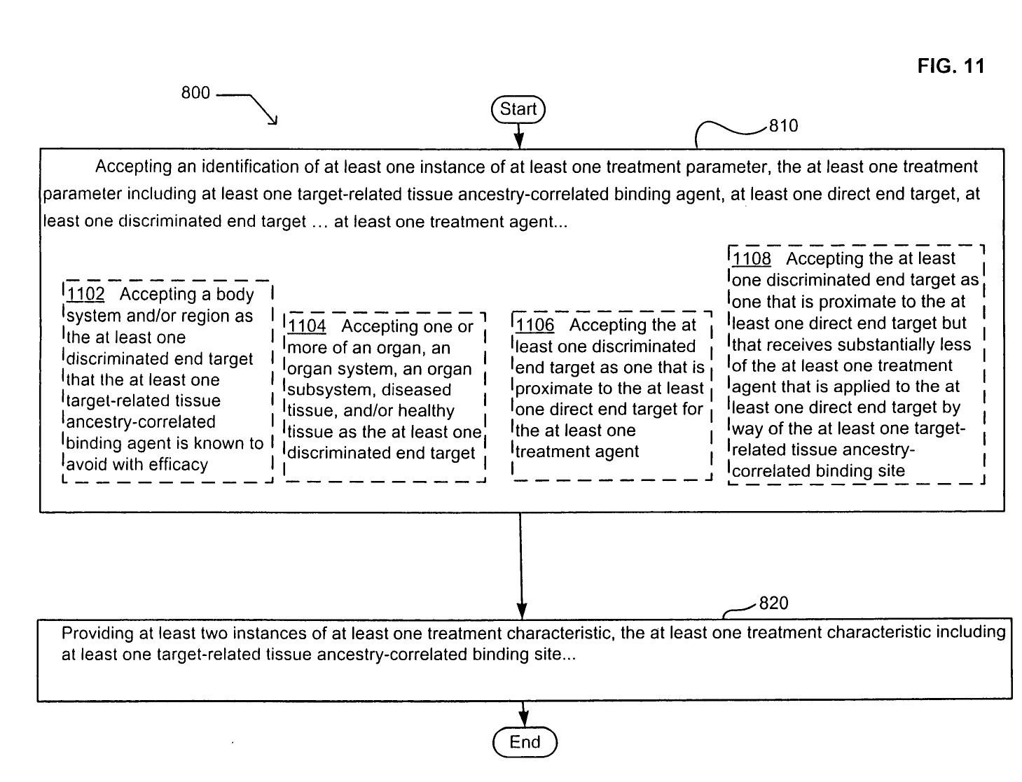

FIG. 11 illustrates alternative embodiments of the example operational flow 800 of FIG. 8. FIG. 11 illustrates example embodiments where the accepting operation 810 may include at least one additional operation. Additional operations may include operation 1102, operation 1104, operation 1106, and/or operation 1108.

At the operation 1102, a body system and/or region may be accepted as the at least one discriminated end target that the at least one target-related tissue ancestry-correlated binding agent is known to avoid with efficacy. For example, where the direct end target 306 includes the diseased tissue 114 in FIG. 1, the discriminated end target 308 may include the healthy lung tissue 112, so that the treatment agent 320 (e.g., including radionuclides) targets the diseased tissue 114, and exposes the healthy tissue 112 to a lesser extent.

At the operation 1104, one or more of an organ, an organ system, an organ subsystem, diseased tissue, and/or healthy tissue may be accepted as the at least one discriminated end target. For example, the treatment logic 128 may accept, from the user interface 132 information about the lungs, liver, pancreas, or other organ, or breast or other tissue, as the discriminated end target 308. Additionally, diseased tissue in these or other organs, e.g., tumors or other cancerous cells, or healthy tissues, e.g., adipose tissue, also may be accepted as the discriminated end target 308.

At the operation 1106, the at least one discriminated end target may be accepted as one that is proximate to the at least one direct end target for the at least one treatment agent. For example, the healthy tissue 112 may be proximate to the diseased tissue 114 within tissue of the lung 108.

At the operation 1108, the at least one discriminated end target may be accepted as one that is proximate to the at least one direct end target but that receives substantially less of at least one treatment agent that is applied to the at least one direct end target by way of the at least one target-related tissue ancestry-correlated binding site. For example, in the row 604 of FIG. 6, in which the illustrated direct end target 306 includes melanoma tumors, the discriminated end target 308 includes (proximate) surrounding non-tumor tissues, and, as described herein, in the example of the row 604, the treatment agent 320 (e.g., the coupled gene) is applied to the melanoma tumors by way of the target-related tissue ancestry-correlated binding site 314 (e.g., integrin AvB3), so that the surrounding non-tumor tissues receive substantially less of the treatment agent 320 (coupled gene) than do the melanoma tumors themselves.

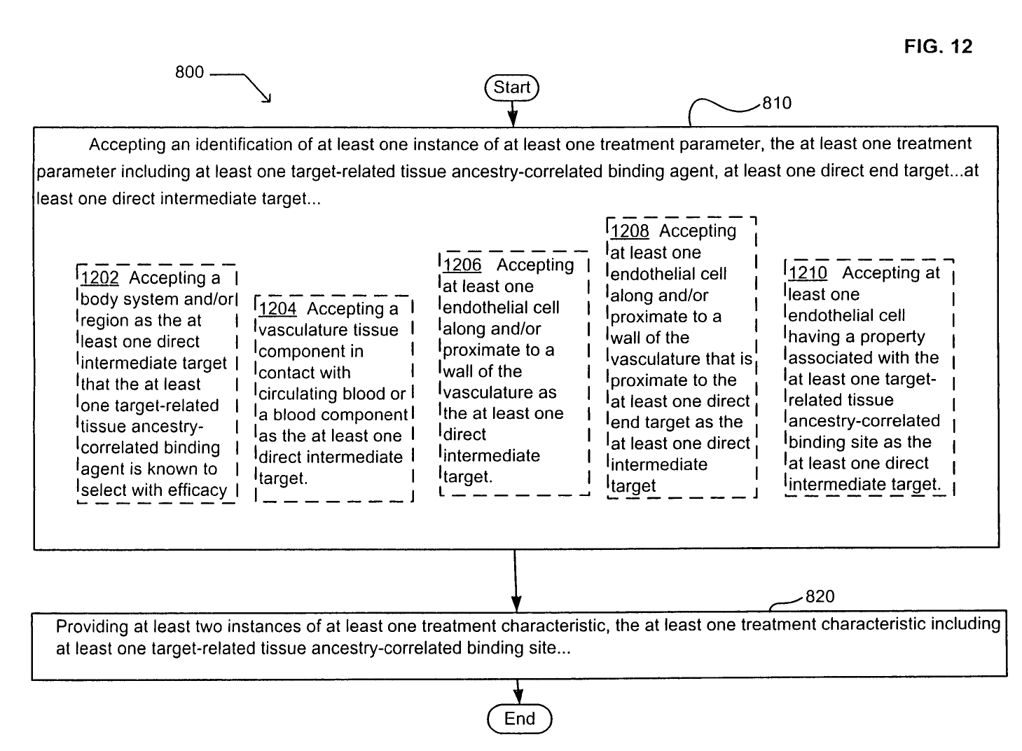

FIG. 12 illustrates alternative embodiments of the example operational flow 800 of FIG. 8. FIG. 12 illustrates example embodiments where the accepting operation 810 may include at least one additional operation. Additional operations may include operation 1202, operation 1204, operation 1206, operation 1208, and/or operation 1210

At the operation 1202, a body system and/or region may be accepted as the at least one direct intermediate target that the at least one target-related tissue ancestry-correlated binding agent is known to select with efficacy. For example, the treatment logic 128 may accept (e.g., by way of the user interface 132) an identification of endothelial cells within the endothelial layer 118 which may be included as the direct intermediate target 308 that the target-related tissue ancestry-correlated binding agent 316 (e.g., I-labeled monoclonal APP antibodies) selects with efficacy.

At the operation 1204, a vasculature tissue component in contact with circulating blood or a blood component may be accepted as the at least one direct intermediate target. For example, the treatment logic 128 may accept (e.g., from the clinician 104) the vasculature tissue component including endothelial cells lining a blood vessel wall and in contact with the circulating blood, as described herein with respect to, for example, rows 502-506 of FIG. 5.

At the operation 1206, at least one endothelial cell along and/or proximate to a wall of the vasculature may be accepted as the at least one direct intermediate target. For example, as illustrated in the row 604 of FIG. 6, endothelial cells having integrin AvB3 may be accepted as the direct intermediate target 308.

At the operation 1208, at least one endothelial cell along or proximate to a wall of the vasculature that is proximate to the at least one direct end target may be accepted as the at least one direct intermediate target. For example, and again as shown in the row 604 of FIG. 4, the endothelial cells having integrin AvB3 may be present along a blood vessel wall that is proximate to the melanoma tumors that may be used as the direct end target 306, and may thus be accepted as the direct intermediate target 308.

At the operation 1210, at least one endothelial cell having a property associated with the at least one target-related tissue ancestry-correlated binding site may be accepted as the at least one direct intermediate target. For example, an endothelial cell in the endothelial layer 118 may have a property (e.g., a displayed protein, such as APP) associated with the target-related tissue ancestry-correlated binding site 316.

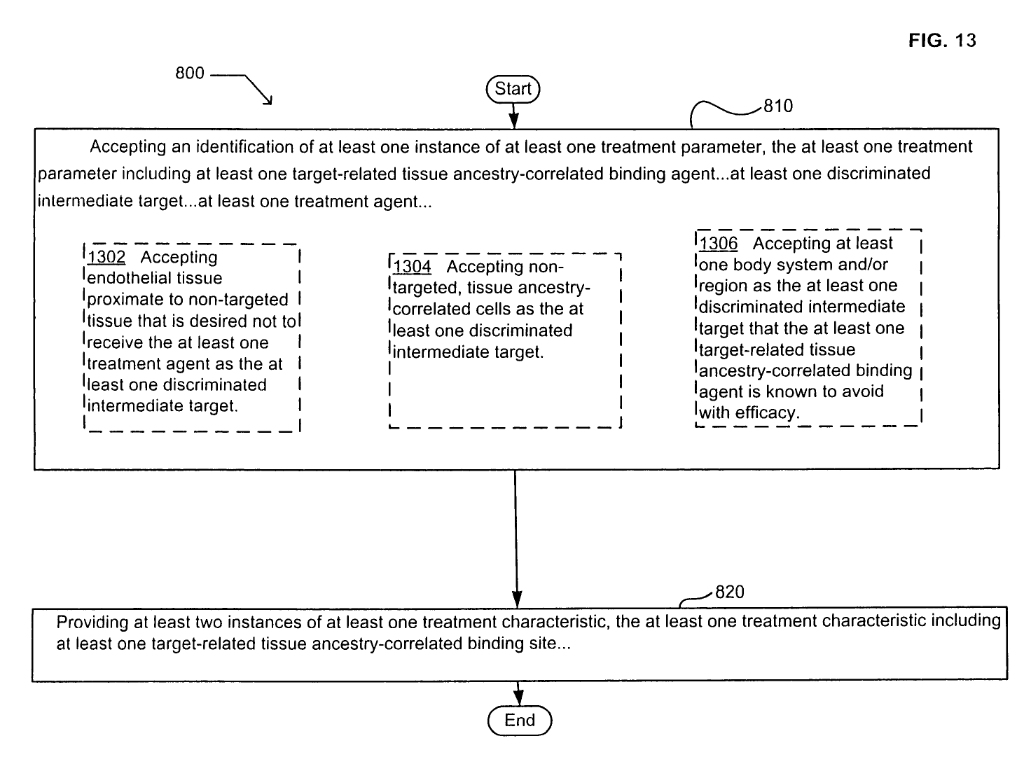

FIG. 13 illustrates alternative embodiments of the example operational flow 800 of FIG. 8. FIG. 13 illustrates example embodiments where the accepting operation 810 may include at least one additional operation. Additional operations may include operation 1302, operation 1304, and/or operation 1306.

At the operation 1302, endothelial tissue proximate to non-targeted tissue that is desired not to receive the at least one treatment agent may be accepted as the at least one discriminated intermediate target. For example, tissue in the endothelial layer 122 that is proximate to (non-targeted) healthy tissue 112 that is desired not to receive the treatment agent 320 (e.g., radionuclides) may be accepted by the treatment logic 128 as the at least one discriminated intermediate target 312.

At the operation 1304, non-targeted, tissue ancestry-correlated cells may be accepted as the at least one discriminated intermediate target. For example, if non-targeted tissue(s) include non-lung tissues when targeted tissue(s) include lung tissues, as in the example of the rows 502 and 504 of FIG. 5, then endothelial cells proximate to the non-targeted, non-lung tissue(s) may be accepted as the at least one discriminated intermediate target 312.

At the operation 1306, at least one body system and/or region may be accepted as the at least one discriminated intermediate target that the at least one target-related tissue ancestry-correlated binding agent is known to avoid with efficacy. For example, in the row 602 of FIG. 6, the vascular beds of pancreas tissue may be accepted by the treatment logic 128 as the discriminated intermediate target 312 that the target-related tissue ancestry-correlated binding agent 316 (e.g., CPGPEGAGC peptide) is known to avoid with efficacy.

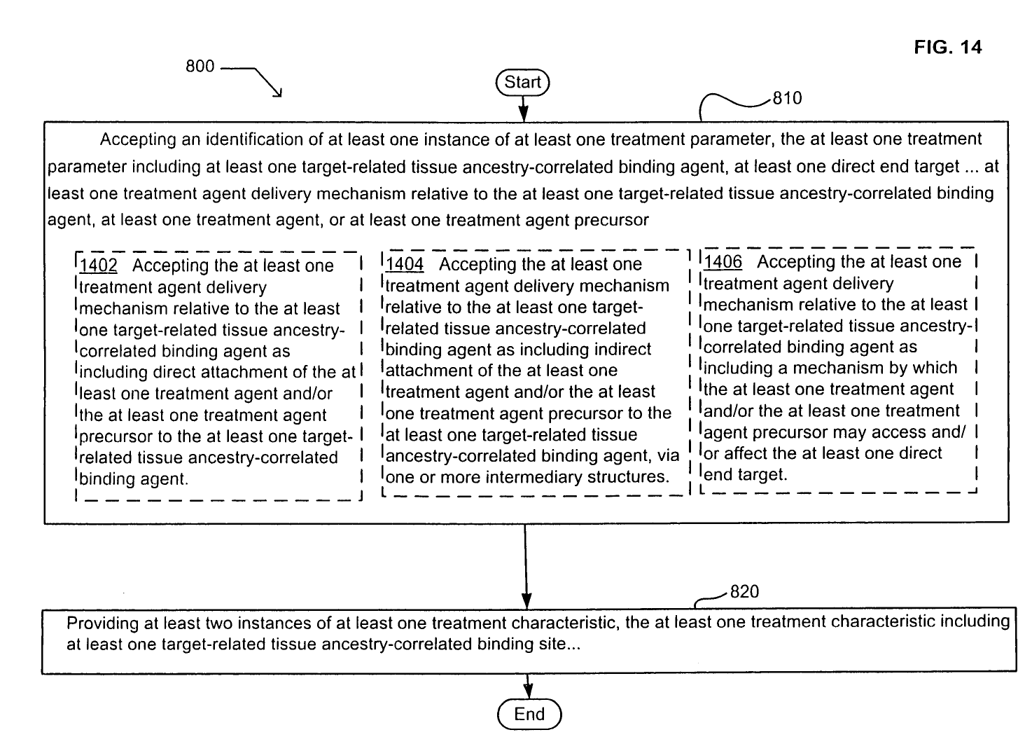

FIG. 14 illustrates alternative embodiments of the example operational flow 800 of FIG. 8. FIG. 14 illustrates example embodiments where the accepting operation 810 may include at least one additional operation. Additional operations may include operation 1402, operation 1404, and/or operation 1406.

At the operation 1402, the at least one treatment agent delivery mechanism relative to the at least one target-related tissue ancestry-correlated binding agent may be accepted as including direct attachment of the at least one treatment agent and/or the at least one treatment agent precursor to the at least one target-related tissue ancestry-correlated binding agent. For example, as in example of the rows 502, 504, and/or 506 of FIG. 5, the described target-related tissue ancestry-correlated binding agent(s) 316, e.g., I-labeled monoclonal antibodies generated for a protein(s) associated with the target-related tissue ancestry-correlated binding site(s) 314, may directly attach to the treatment agent 320, e.g., low levels of radionuclides.

At the operation 1404, the at least one treatment agent delivery mechanism relative to the at least one target-related tissue ancestry-correlated binding agent may be accepted as including indirect attachment of the at least one treatment agent and/or the at least one treatment agent precursor to the at least one target-related tissue ancestry-correlated binding agent, via one or more intermediary structures. For example, as in the row 604 of FIG. 6, cationic polymerized lipid-based nanoparticles may be used to attach a coupled gene acting as the treatment agent 320 to an AvB3 ligand being used as the target-related tissue ancestry-correlated binding agent 316, for delivery of the coupled gene to the, in this example, vascular beds of breast tissue acting as the direct intermediate target 312.

At the operation 1406, the at least one treatment agent delivery mechanism relative to the at least one target-related tissue ancestry-correlated binding agent may be accepted as including a mechanism by which the at least one treatment agent and/or the at least one treatment agent precursor may access and/or affect the at least one direct end target. For example, again referring to the row 604 of FIG. 6, the cationic polymerized lipid-based nanoparticles may be used to affect the direct end target 306, e.g., melanoma tumors.

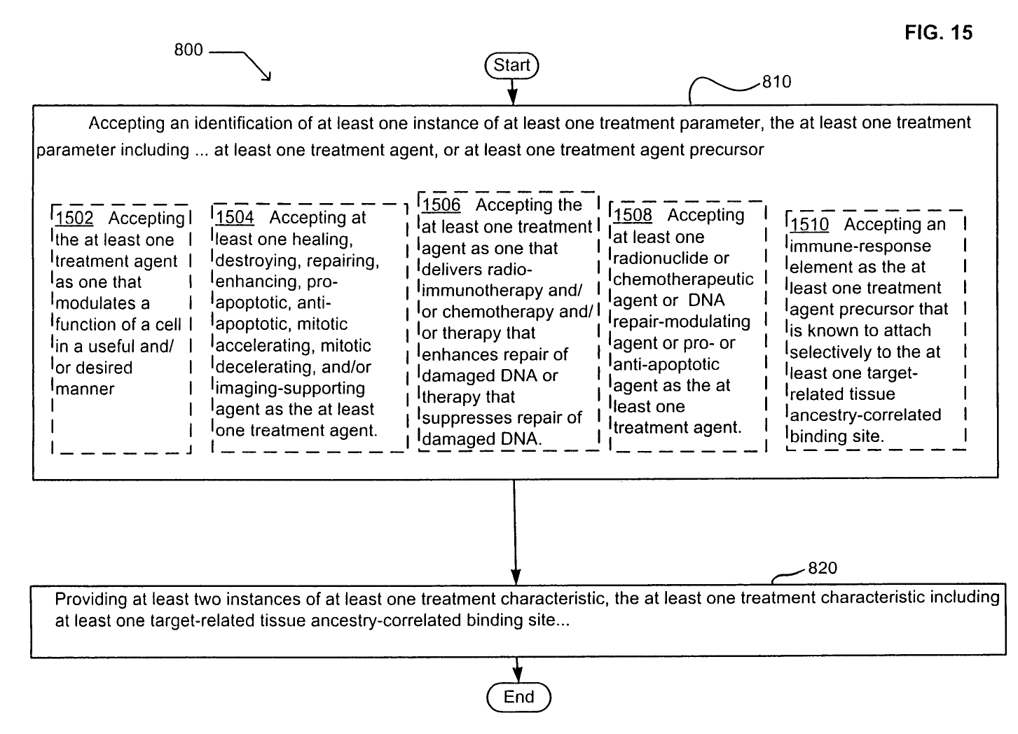

FIG. 15 illustrates alternative embodiments of the example operational flow 800 of FIG. 8. FIG. 15 illustrates example embodiments where the accepting operation 820 may include at least one additional operation. Additional operations may include operation 1502, operation 1504, operation 1506, operation 1508, and/or operation 1510.

At the operation 1502, the at least one treatment agent may be accepted by the treatment logic 128 as one that modulates a function of a cell in a useful and/or desired manner. For example, the treatment agent 320 may include various chemical, biological, or genetic agents accepted by the treatment logic 128 and stored in the treatment data 126 for use by the treatment system 102.

At the operation 1504, at least one healing, destroying, repairing, enhancing, pro-apoptotic, anti-apoptotic, mitotic accelerating, mitotic decelerating, and/or imaging-supporting agent may be accepted as the at least one treatment agent. For example, in the row 604 of FIG. 6, a desired gene may be accepted that may be coupled to the target-related tissue ancestry-correlated binding agent 316 (e.g., through use of a nanoparticle(s), as described), for disrupting formation of new blood vessels in the described melanoma tumor(s),and for thereby depriving the tumor(s) of blood and inhibiting the tumor(s). As another example, an imagine agent may be accepted as the treatment agent 320 that targets a desired body portion or region that is to be imaged, and that thereby facilitates accurate and selective imaging of the body portion or region.

At the operation 1506, the at least one treatment agent may be accepted as one that delivers radio-immunotherapy and/or chemotherapy and/or therapy that enhances repair of damaged DNA or therapy that suppresses repair of damaged DNA. For example, in the row 502 of FIG. 5, the treatment agent 320 stored in the treatment data 126 may be accepted by the treatment logic 128 as including radio-immunotherapy through low-levels of radionuclides.

At the operation 1508, at least one radionuclide or chemotherapeutic agent or DNA repair-modulating agent or pro- or anti-apoptotic agent may be accepted as the at least one treatment agent. For example, and similar to the example just mentioned, the row 506 illustrates use of a radionuclide as the treatment agent 320 used to attempt to destroy or reduce the direct end target 306 of diseased lung tissue.

At the operation 1510, an immune-response element may be accepted as the at least one treatment agent precursor that is known to attach selectively to the at least one target-related tissue ancestry-correlated binding site. For example, as in the row 602 of FIG. 6, phages may be used as the treatment agent precursor 402.

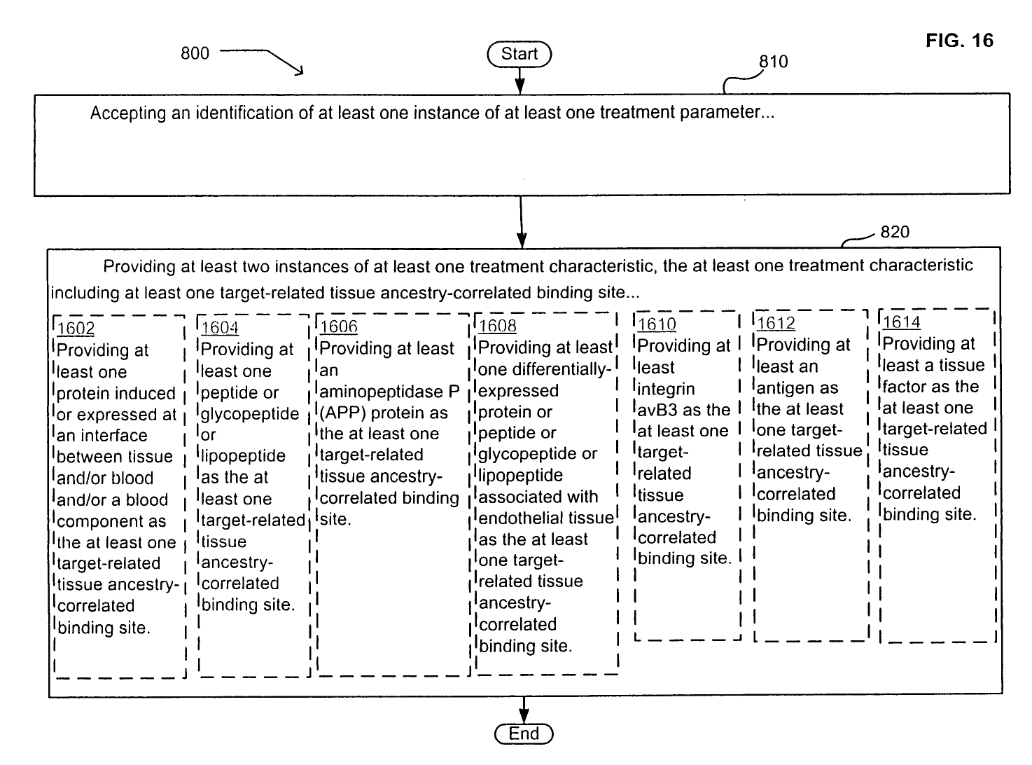

FIG. 16 illustrates alternative embodiments of the example operational flow 800 of FIG. 8. FIG. 16 illustrates example embodiments where the providing operation 820 may include at least one additional operation. Additional operations may include operation 1602, operation 1604, operation 1606, operation 1608, operation 1610, 1612, and/or operation 1614.

At the operation 1602, at least one protein induced and/or expressed at an interface between tissue and/or blood and/or a blood component may be provided as the at least one target-related tissue ancestry-correlated binding site. For example, as referenced herein, the treatment logic 128 may accept, e.g., by way of the user interface 132, a protein expressed at an endothelial layer 118 to be used as the target-related tissue ancestry-correlated binding site.

At the operation 1604, at least one peptide or glycopeptide or lipopeptide may be provided as the at least one target-related tissue ancestry-correlated binding site. For example, the treatment logic 128 may provide, e.g., from the treatment data 126 and by way of the user interface 132, a peptide as a selected in vivo target for antibodies in specified healthy and/or diseased tissues.

At the operation 1606, at least an aminopeptidase P (APP) protein may be provided as the at least one target-related tissue ancestry-correlated binding site. For example, and with reference to rows 502 and/or 504 of FIG. 5, the treatment logic 128 may provide, e.g., by way of the user interface 132, APP as an instance of the target-related tissue ancestry-correlated binding site 314.

At the operation 1608, at least one differentially-expressed protein or peptide or glycopeptide or lipopeptide associated with endothelial tissue may be provided as the at least one target-related tissue ancestry-correlated binding site. For example, and with reference to the row 506 of FIG. 5, the treatment logic 128 may provide, e.g., by way of the user interface 132, such a differentially-expressed protein as an instance of the target-related tissue ancestry-correlated binding site 314, for targeting thereof with an appropriate antibody and subsequent delivery of the associated/attached treatment agent 320 to diseased lung tissue as an instance of the direct end target 306.

At the operation 1610, at least integrin avB3 may be provided as the at least one target-related tissue ancestry-correlated binding site. For example, and with reference to the row 604 of FIG. 6, the treatment logic 128 may provide, e.g., from the treatment data 126 and by way of the user interface 132, integrin avB3 as a target for delivering a desired gene to melanoma tumor cells, without delivering the gene to surrounding, non-cancerous cells.

At the operation 1612, at least an antigen may be provided as the at least one target-related tissue ancestry-correlated binding site. For example, and with reference to the row 702 of FIG. 7, the treatment logic 128 may provide, e.g., by way of the user interface 132, an antigen to which the monoclonal antibody TX3.833 binds, in order to provide (e.g., as part of the providing operation 820) the clinician 104 with information that such an antigen may be used to direct the TX3.833 antibody thereto. As used herein, the term antigen or epitope may be used interchangeably in some circumstances, and, e.g., may refer generally to an immunogenic or immuno-targeted entity present in the vasculature unless context dictates otherwise.

At the operation 1614, at least a tissue factor may be provided as the at least one target-related tissue ancestry-correlated binding site. For example, and with reference to the row 704 of FIG. 7, the treatment logic 128 may provide, e.g., by way of the user interface 132, a tissue factor having a known and associated (e.g., associated within the treatment data 126) ligand therefore (e.g., fVII), so that the ligand may be provided as part of the providing operation 820.

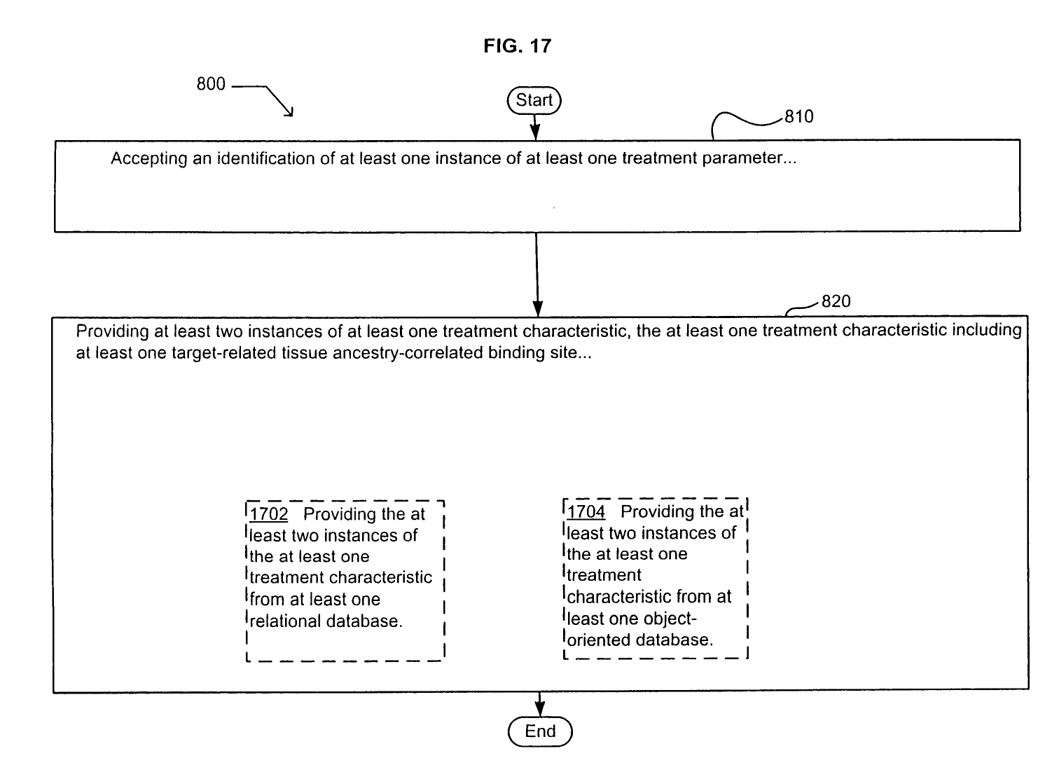

FIG. 17 illustrates alternative embodiments of the example operational flow 800 of FIG. 8. FIG. 17 illustrates example embodiments where the providing operation 820 may include at least one additional operation. Additional operations may include operation 1702, and/or operation 1704.

At the operation 1702, the at least two instances of the at least one treatment characteristic may be provided from at least one relational database. For example, the at least two instances of the at least one treatment characteristic may be provided from the treatment data 126, which may include one or more relational database(s).

At the operation 1704, the at least two instances of the at least one treatment characteristic may be provided from at least one object-oriented database. For example, the at least two instances of the at least one treatment characteristic may be provided from the treatment data 126, which may include one or more object-oriented database(s).

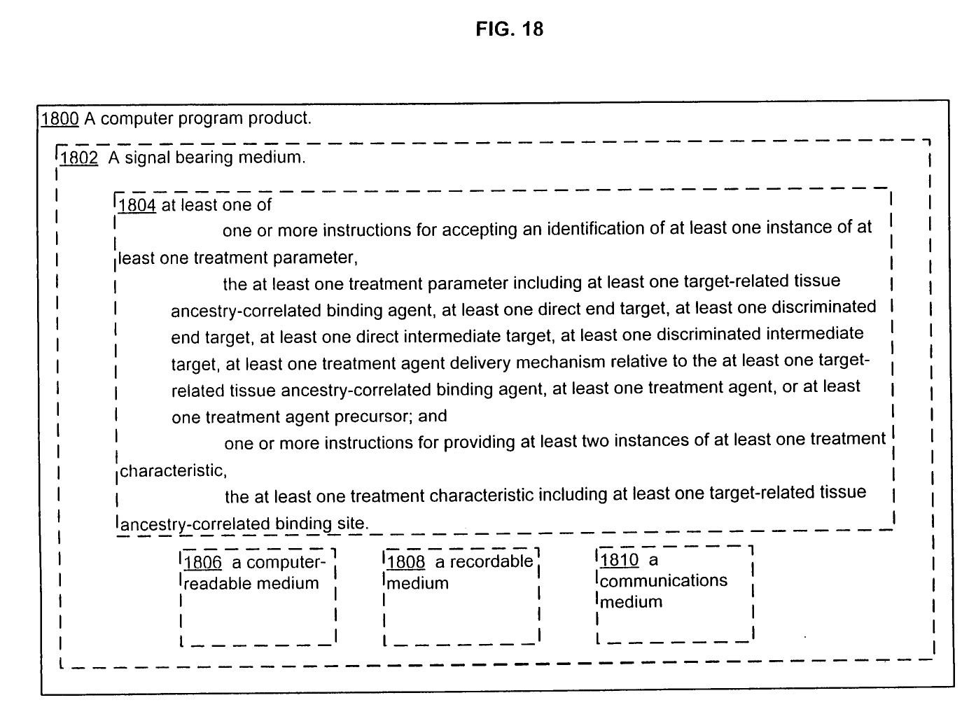

FIG. 18 illustrates a partial view of an example computer program product 1800 that includes a computer program 1804 for executing a computer process on a computing device. An embodiment of the example computer program product 1800 is provided using a signal bearing medium 1802, and may include at least one of one or more instructions for accepting an identification of at least one instance of at least one treatment parameter, the at least one treatment parameter including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and one or more instructions for providing at least two instances of at least one treatment characteristic, the at least one treatment characteristic including at least one target-related tissue ancestry-correlated binding site. The one or more instructions may be, for example, computer executable and/or logic-implemented instructions. In one implementation, the signal-bearing medium 1802 may include a computer-readable medium 1806. In one implementation, the signal bearing medium 1802 may include a recordable medium 1808. In one implementation, the signal bearing medium 1802 may include a communications medium 1810.

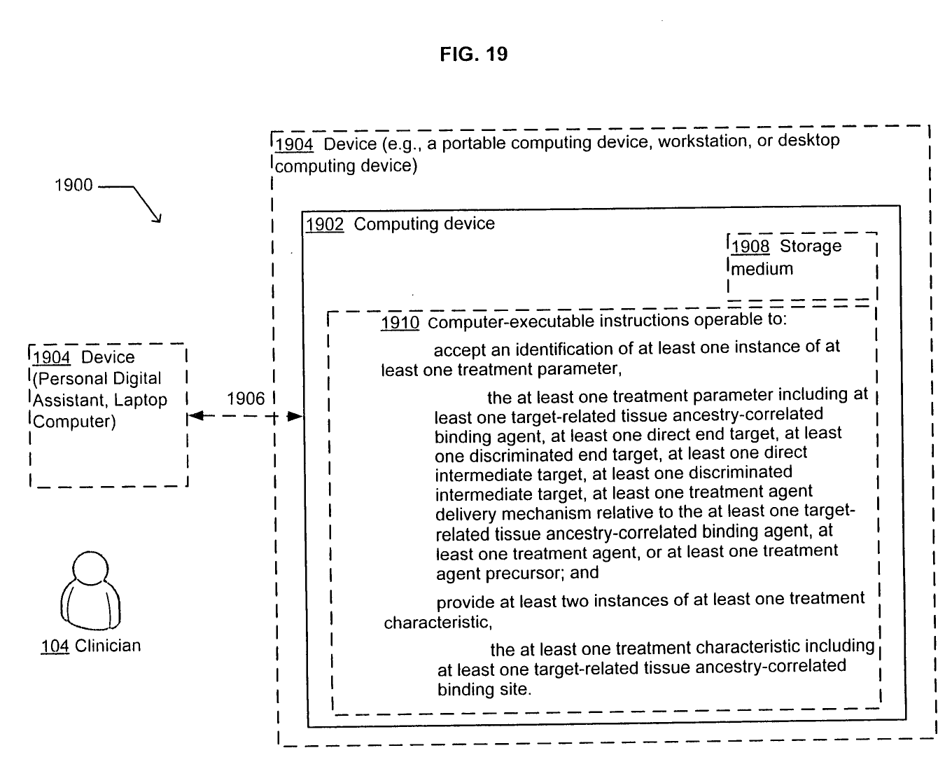

FIG. 19 illustrates an example system 1900 in which embodiments may be implemented. The system 1900 includes a computing system environment. The system 1900 also illustrates the clinician 104 using a device 1904, which is optionally shown as being in communication with a computing device 1902 by way of an optional coupling 1906. The optional coupling 1906 may represent a local, wide-area, or peer-to-peer network, or may represent a bus that is internal to a computing device (e.g., in example embodiments in which the computing device 1902 is contained in whole or in part within the device 1904). A storage medium 1908 may be any computer storage media.

The computing device 1902 includes computer-executable instructions 1910 that when executed on the computing device 1902 cause the computing device 1902 to accept an identification of at least one instance of at least one treatment parameter, the at least one treatment parameter including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor, and provide at least two instances of at least one treatment characteristic, the at least one treatment characteristic including at least one target-related tissue ancestry-correlated binding site. As referenced above and as shown in FIG. 19, in some examples, the computing device 1902 may optionally be contained in whole or in part within the clinician device 1904.

In FIG. 19, then, the system 1900 includes at least one computing device (e.g., 1902 and/or 1904). The computer-executable instructions 110 may be executed on one or more of the at least one computing device. For example, the computing device 1902 may implement the computer-executable instructions 110 and output a result to (and/or receive data from) the computing (clinician) device 1904. Since the computing device 1902 may be wholly or partially contained within the computing (clinician) device 1904, the computing (clinician) device 1904 also may be said to execute some or all of the computer-executable instructions 110, in order to be caused to perform or implement, for example, various ones of the techniques described herein, or other techniques.

The clinician device 1904 may include, for example, one or more of a personal digital assistant (PDA), a laptop computer, a tablet personal computer, a networked computer, a computing system comprised of a cluster of processors, a workstation computer, and/or a desktop computer. In another example embodiment, the computing device 1902 may be operable to communicate with the clinician device 1904 associated with the clinician 104 to receive information regarding the identification and to provide the at least two instances of the at least one treatment characteristic from at least one memory.

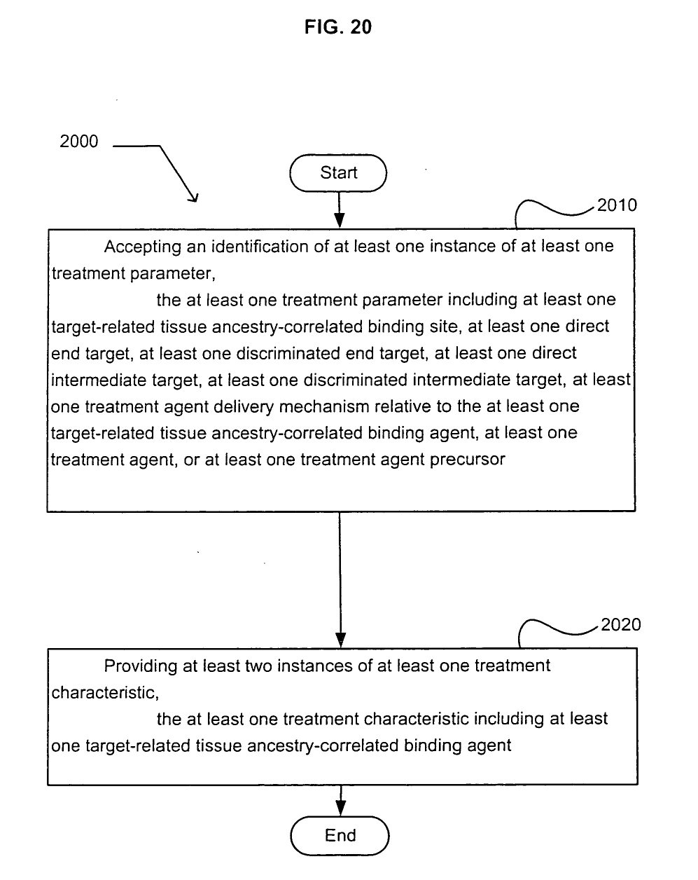

FIG. 20 illustrates an operational flow 2000 representing example operations related to accessing data related to tissue coding. After a start operation, the operational flow 2000 moves to an accepting operation 2010 where an identification of at least one instance of at least one treatment parameter is accepted, the at least one treatment parameter including at least one target-related tissue ancestry-correlated binding site, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. For example, the treatment logic 128 may accept, e.g., from the clinician 104 by way of the user interface 132, the target-related tissue ancestry-correlated binding site 314, such as, for example, two or more of the fifteen differentially-expressed proteins referenced in the row 506 of FIG. 5.

In a providing operation 2020, at least two instances of at least one treatment characteristic may be provided, where the at least one treatment characteristic may include at least one target-related tissue ancestry-correlated binding agent. For example, the treatment logic 128 of the treatment system 102 may provide, e.g., by way of the user interface 132, an identification of at least one instance of the target-related tissue ancestry-correlated binding agent 316, such as, for example, one or more appropriate (types of) binding I-labeled monoclonal antibodies.

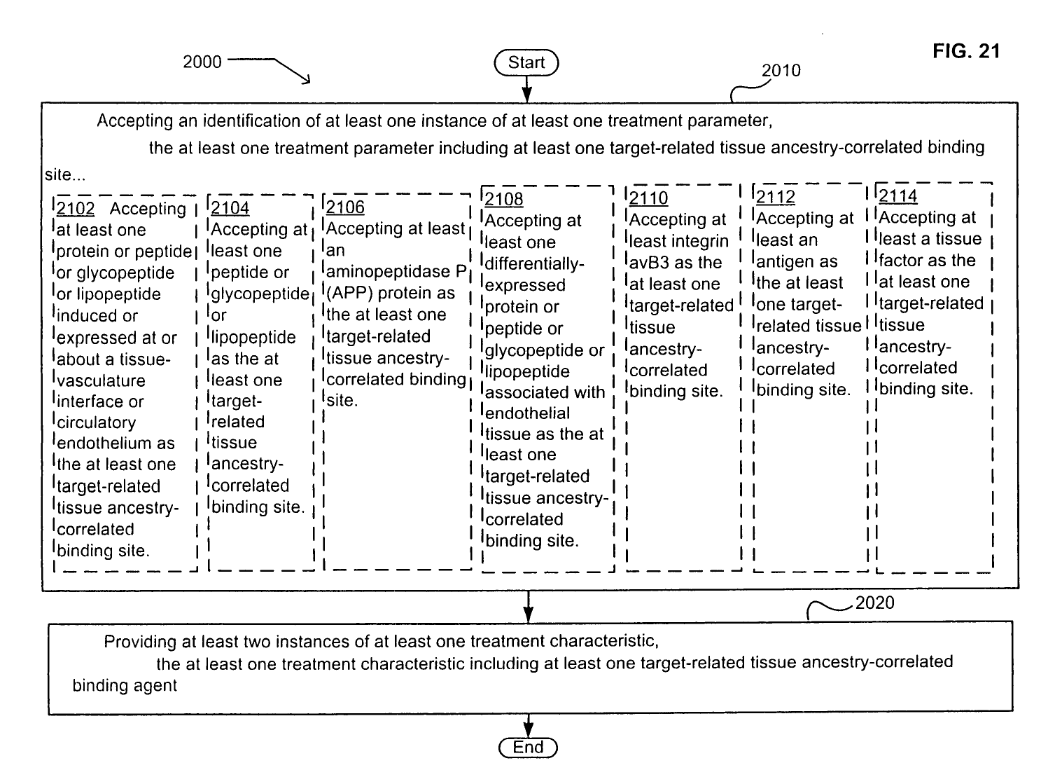

FIG. 21 illustrates an alternative embodiment of the example operational flow of FIG. 20. FIG. 21 illustrates example embodiments where the accepting operation 2010 may include at least one additional operation. Additional operations may include operation 2102, operation 2104, operation 2106, operation 2108, operation 2110, operation 2112, and/or operation 2114.

At the operation 2102, at least one protein or peptide or glycopeptide or lipopeptide induced or expressed at or about a tissue-vasculature interface or circulatory endothelium may be accepted as the at least one target-related tissue ancestry-correlated binding site. For example, as referenced herein, the treatment logic 128 may accept, from the clinician 104, a protein induced at an endothelial layer 118 to be used as the target-related tissue ancestry-correlated binding site.

At the operation 2104, at least one peptide or glycopeptide or lipopeptide may be accepted as the at least one target-related tissue ancestry-correlated binding site. For example, the treatment logic 128 may accept from the clinician 104 a peptide as a selected in vivo target for antibodies in specified healthy and/or diseased tissues.

At the operation 2106, at least an aminopeptidase P (APP) protein may be accepted as the at least one target-related tissue ancestry-correlated binding site. For example, as shown in rows 502 and/or 504 of FIG. 5, the treatment logic 128 may accept, by way of the user interface 132, APP as an instance of the target-related tissue ancestry-correlated binding site 314.

At the operation 2108, at least one differentially-expressed protein or peptide or glycopeptide or lipopeptide associated with endothelial tissue may be accepted as the at least one target-related tissue ancestry-correlated binding site. For example, as shown in the row 506 of FIG. 5, the treatment logic 128 may accept such a differentially-expressed protein or peptide or glycopeptide or lipopeptide as an instance of the target-related tissue ancestry-correlated binding site 314, for targeting thereof with an appropriate antibody and subsequent delivery of the associated/attached treatment agent 320 to diseased lung tissue as an instance of the direct end target 306.

At the operation 2110, at least integrin avB3 may be accepted as the at least one target-related tissue ancestry-correlated binding site. For example, as shown in the row 604 of FIG. 6, the treatment logic 128 may accept from the clinician 104 integrin avB3 as a target for delivering a desired gene to melanoma tumor cells, without delivering the gene to surrounding, non-cancerous cells.

At the operation 2112, at least an antigen may be accepted as the at least one target-related tissue ancestry-correlated binding site. For example, as shown in the row 702 of FIG. 7, the treatment logic 128 may accept from the clinician 104 an antigen to which the monoclonal antibody TX3.833 binds, in order to thereafter provide information that such an antigen may be used to direct the TX3.833 antibody thereto.

At the operation 2114, at least a tissue factor may be accepted as the at least one target-related tissue ancestry-correlated binding site. For example, as shown in the row 7.04 of FIG. 7, the treatment logic 128 may accept by way of the user interface 132 a tissue factor having a known and associated ligand therefore (e.g., fVII).

Additionally, although FIG. 21 is illustrated with respect to (instance(s) of) a target-related tissue ancestry-correlated binding site(s), one skilled in the art will recognize that the one or more instances of at least one treatment parameter(s) may be accepted, where examples of the treatment parameter(s) are provided above, for example, with respect to FIGS. 10-15.

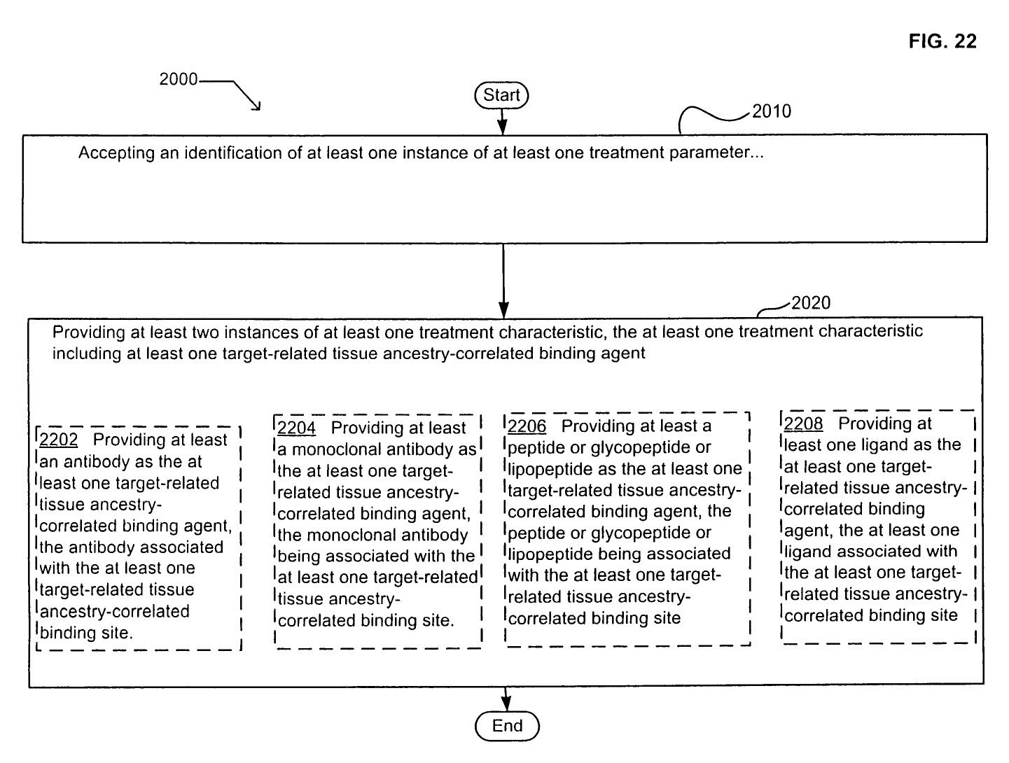

FIG. 22 illustrates an alternative embodiment of the example operational flow of FIG. 20. FIG. 22 illustrates example embodiments where the providing operation 2020 may include at least one additional operation. Additional operations may include operation 2202, operation 2204, operation 2206, and/or operation 2208.

At the operation 2202, at least an antibody is provided as the at least one target-related tissue ancestry-correlated binding agent, the antibody associated with the at least one target-related tissue ancestry-correlated binding site. For example, as shown in rows 502, 504, and 506 of FIG. 5, and as shown in the row 702 of FIG. 7, various types of antibodies may be provided by the treatment logic 128 as instance(s) of the target-related tissue ancestry-correlated binding agent 316, where the antibodies may be associated, e.g., in the treatment data 126, with corresponding instances of the target-related tissue ancestry-correlated binding site 314 (e.g., APP and/or antigen).

At the operation 2204, at least a monoclonal antibody may be provided as the at least one target-related tissue ancestry-correlated binding agent, the monoclonal antibody being associated with the at least one target-related tissue ancestry-correlated binding site. For example, as again shown in rows 502, 504, and 506 of FIG. 5, and as shown in the row 702 of FIG. 7, various types of I-labeled monoclonal antibodies may be appropriately provided as instance(s) of the target-related tissue ancestry-correlated binding agent 316, which may be stored in association with corresponding instances of the target-related tissue ancestry-correlated binding site 314, within the treatment data 126 of the treatment system 102. In this way, the (monoclonal) antibodies may be used to target the corresponding target-related tissue ancestry-correlated binding site(s), for delivery of a desired instance of the treatment agent 320, as described herein.

At the operation 2206, at least a peptide or glycopeptide or lipopeptide may be provided as the at least one target-related tissue ancestry-correlated binding agent, the peptide or glycopeptide or lipopeptide being associated with the at least one target-related tissue ancestry-correlated binding site. For example, as shown in the row 602 of FIG. 6, the treatment data 126 may store the CPGPEGAGC peptide as the target-related tissue ancestry-correlated binding agent 316, where the CPGPEGAGC is known to bind to a target-related tissue ancestry-correlated binding site such as APP, e.g., the APP of vascular bed(s) of breast tissue, so that the treatment logic 128 may provide the CPGPEGAGC peptide accordingly.

At the operation 2208, at least one ligand may be provided as the at least one target-related tissue ancestry-correlated binding agent, the at least one ligand associated with the at least one target-related tissue ancestry-correlated binding site. For example, as shown in the row 704 of FIG. 7, the ligand fVII may be provided as the target-related tissue ancestry-correlated binding agent 316, e.g., based on an earlier accepting of the target-related tissue ancestry-correlated binding site 314 of tissue, and based on a corresponding association that may be stored within the treatment data 126.

In addition to references described above, the following are also hereby incorporated by reference in their entireties to the extent such are not inconsistent herewith:

Pasqualini et al., “Probing the Structural and Molecular Diversity of Tumor Vasculature,” TRENDS in Molecular Medicine, vol. 8, No. 12, pp. 563-571 (December 2002);

Aird et al., “Vascular Bed-specific Expression of an Endothelial Cell Gene is Programmed by the Tissue Microenvironment,” The Journal of Cell Biology, vol. 138, No. 5, pp. 1117-1124 (Sep. 8, 1997);

Pasqualini et al., “Organ Targeting In Vivo Using Phage Display Peptide Libraries,” Nature, vol. 380, pp. 364-366 (Mar. 28, 1996);

Rajotte et al., “Molecular Heterogeneity of the Vascular Endothelium Revealed by In Vivo Phage Display,” J. Clin. Invest., vol. 102, No. 2, pp. 430-437 (July 1998);

M'Rini, et al., “A Novel Endothelial L-Selectin Ligand Activity in Lymph Node Medulla That Is Regulated by (1,3)-Fucosyltransferase-IV,” J. Exp. Med., vol. 198, No. 9, pp. 1301-1312 (Nov. 3, 2003);

Carver, et al., “Caveolae: Mining Little Caves for New Cancer Targets,” Nature Reviews, vol. 3, pp. 571-572 (August 2003);

Folkman, Judah, “Looking For A Good Endothelial Address,” Cancer Cell, pp. 113-115 (March 2002);

Brody, Lawrence C., “Treating Cancer by Targeting a Weakness,” N Engl J Med. 353; 9 pp. 949-950 (1 Sep. 2005);

Farmer, et al., “Targeting the DNA Repair Defect in BRCA Mutant Cells as a Therapeutic Strategy,” Nature, vol. 434, pp. 917-921 (14 Apr. 2005);

Bryant, et al., “Specific Killing of BRCA2-Deficient Tumours with Inhibitors of poly(ADP-ribose) Polymerase,” Nature, vol. 434, pp. 913-917 (14 Apr. 2005).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While certain features of the described implementations have been illustrated as disclosed herein, many modifications, substitutions, changes and equivalents will now occur to those skilled in the art. It is, therefore, to be understood that the appended claims are intended to cover all such modifications and changes as fall within the true spirit of the embodiments of the invention.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations.” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., ” a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., ” a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A treatment system comprising: means for accepting identification of at least one instance of at least one treatment parameter,
the at least one treatment parameter including at least one target-related tissue ancestry-correlated binding agent, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor; and
means for providing at least two instances of at least one treatment characteristic,
the at least one treatment characteristic including at least one target-related tissue ancestry-correlated binding site.

2. The treatment system of claim 1 wherein the means for accepting an identification of at least one instance of at least one treatment parameter, the at least one treatment parameter including at least one target-related tissue ancestry-correlated binding agent, comprises:
means for accepting at least an antibody as the at least one target-related tissue ancestry-correlated binding agent, the antibody being associated with the at least one target-related tissue ancestry-correlated binding site.

3. (canceled)

4. (canceled)

5. The treatment system of claim 1 wherein the means for accepting an identification of at least one instance of at least one treatment parameter, the at least one treatment parameter including at least one target-related tissue ancestry-correlated binding agent, comprises:
means for accepting at least one ligand as the at least one target-related tissue ancestry-correlated binding agent, the at least one ligand associated with the at least one target-related tissue ancestry-correlated binding site.

6. (canceled)

7. The treatment system of claim 1 wherein the means for accepting an identification of at least one instance of at least one treatment parameter, the at least one treatment parameter including at least one direct end target, comprises:
means for accepting one or more of an organ, an organ system, an organ subsystem, diseased tissue, and/or healthy tissue as the at least one direct end target.

8. The treatment system of claim 1 wherein the means for accepting an identification of at least one instance of at least one treatment parameter, the at least one treatment parameter including at least one direct end target, comprises:
means for accepting at least one direct end target as one that is associated with the at least one target-related tissue ancestry-correlated binding site.

9. (canceled)

10. (canceled)

11. The treatment system of claim 1 wherein the means for accepting an identification of at least one instance of at least one treatment parameter, the at least one treatment parameter including at least one discriminated end target, comprises:
means for accepting one or more of an organ, an organ system, an organ subsystem, diseased tissue, and/or healthy tissue as the at least one discriminated end target.

12. The treatment system of claim 1 wherein the means for accepting an identification of at least one instance of at least one treatment parameter, the at least one treatment parameter including at least one direct end target, at least one discriminated end target, or at least one treatment agent, comprises:
means for accepting the at least one discriminated end target as one that is proximate to the at least one direct end target for the at least one treatment agent.

13. (canceled)

14. (canceled)

15. The treatment system of claim 1 wherein the means for accepting an identification of at least one instance of at least one treatment parameter, the at least one treatment parameter including at least one direct intermediate target, comprises:
means for accepting a vasculature tissue component in contact with circulating blood or a blood component as the at least one direct intermediate target.

16. The treatment system of claim 1 wherein the means for accepting an identification of at least one instance of at least one treatment parameter, the at least one treatment parameter including at least one direct intermediate target, comprises:
means for accepting at least one endothelial cell along and/or proximate to a wall of the vasculature as the at least one direct intermediate target.

17. The treatment system of claim 1 wherein the means for accepting an identification of at least one instance of at least one treatment parameter, the at least one treatment parameter including at least one direct end target or at least one direct intermediate target, comprises:
means for accepting at least one endothelial cell along and/or proximate to a wall of the vasculature that is proximate to the at least one direct end target as the at least one direct intermediate target.

18. The treatment system of claim 1 wherein the means for accepting an identification of at least one instance of at least one treatment parameter, the at least one treatment parameter including at least one direct intermediate target, comprises:
means for accepting at least one endothelial cell having a property associated with the at least one target-related tissue ancestry-correlated binding site as the at least one direct intermediate target.

19. (canceled)

20. The treatment system of claim 1 wherein the means for accepting an identification of at least one instance of at least one treatment parameter, the at least one treatment parameter including at least one discriminated intermediate target, comprises:
means for accepting non-targeted, tissue ancestry-correlated cells as the at least one discriminated intermediate target.

21. The treatment system of claim 1 wherein the means for accepting an identification of at least one instance of at least one treatment parameter, the at least one treatment parameter including at least one target-related tissue ancestry-correlated binding agent, or at least one discriminated intermediate target, comprises:
means for accepting at least one body system and/or region as the at least one discriminated intermediate target that the at least one target-related tissue ancestry-correlated binding agent is known to avoid with efficacy.

22. The treatment system of claim 1 wherein the means for accepting an identification of at least one instance of at least one treatment parameter, the at least one treatment parameter including at least one target-related tissue ancestry-correlated binding agent, at least one treatment agent delivery mechanism relative to the at least one target-related tissue ancestry-correlated binding agent, at least one treatment agent, or at least one treatment agent precursor, comprises:
means for accepting the at least one treatment agent delivery mechanism relative to the at least one target-related tissue ancestry-correlated binding agent as including direct attachment of the at least one treatment agent and/or the at least one treatment agent precursor to the at least one target-related tissue ancestry-correlated binding agent.

23. The treatment system of claim 1 wherein the means for accepting an identification of at least one instance of at least one treatment parameter, the at least one treatment parameter including at least one target-related tissue ancestry-correlated binding agent, at least one treatment agent delivery mechanism relative to the at least one target-related tissue ancestry-correlated binding agent, at least one treatment agent, or at least one treatment agent precursor, comprises:
means for accepting the at least one treatment agent delivery mechanism relative to the at least one target-related tissue ancestry-correlated binding agent as including indirect attachment of the at least one treatment agent and/or the at least one treatment agent precursor to the at least one target-related tissue ancestry-correlated binding agent, via one or more intermediary structures.

24. The treatment system of claim 1 wherein the means for accepting an identification of at least one instance of at least one treatment parameter, the at least one treatment parameter including at least one target-related tissue ancestry-correlated binding agent, at least one direct end target, at least one treatment agent delivery mechanism relative to the at least one target-related tissue ancestry-correlated binding agent, at least one treatment agent, or at least one treatment agent precursor, comprises:
means for accepting the at least one treatment agent delivery mechanism relative to the at least one target-related tissue ancestry-correlated binding agent as including a mechanism by which the at least one treatment agent and/or the at least one treatment agent precursor may access and/or affect the at least one direct end target.

25. The treatment system of claim 1 wherein the means for accepting an identification of at least one instance of at least one treatment parameter, the at least one treatment parameter including at least one treatment agent, comprises:
means for accepting the at least one treatment agent as one that modulates a function of a cell in a useful and/or desired manner.

26. (canceled)

27. The treatment system of claim 1 wherein the means for accepting an identification of at least one instance of at least one treatment parameter, the at least one treatment parameter including at least one treatment agent, comprises:
means for accepting the at least one treatment agent as one that delivers radio-immunotherapy and/or chemotherapy and/or therapy that enhances repair of damaged DNA or therapy that suppresses repair of damaged DNA.

28. The treatment system of claim 1 wherein the means for accepting an identification of at least one instance of at least one treatment parameter, the at least one treatment parameter including at least one treatment agent, comprises:
means for accepting at least one radionuclide or chemotherapeutic agent or DNA repair-modulating agent or pro- or anti-apoptotic agent as the at least one treatment agent.

29. The treatment system of claim 1 wherein the means for accepting an identification of at least one instance of at least one treatment parameter, the at least one treatment parameter including at least one treatment agent precursor, comprises:
means for accepting an immune-response element as the at least one treatment agent precursor that is known to attach selectively to the at least one target-related tissue ancestry-correlated binding site.

30. The treatment system of claim 1 wherein the means for providing at least two instances of at least one treatment characteristic, the at least one treatment characteristic including at least one target-related tissue ancestry-correlated binding site, comprises:
means for providing at least one protein induced or expressed at an interface between tissue and/or blood and/or a blood component as the at least one target-related tissue ancestry-correlated binding site.

31. The treatment system of claim 1 wherein the means for providing at least two instances of at least one treatment characteristic, the at least one treatment characteristic including at least one target-related tissue ancestry-correlated binding site, comprises:
means for providing at least one peptide or glycopeptide or lipopeptide as the at least one target-related tissue ancestry-correlated binding site.

32. The treatment system of claim 1 wherein the means for providing at least two instances of at least one treatment characteristic, the at least one treatment characteristic including at least one target-related tissue ancestry-correlated binding site, comprises:
means for providing at least an aminopeptidase P (APP) protein as the at least one target-related tissue ancestry-correlated binding site.

33. The treatment system of claim 1 wherein the means for providing at least two instances of at least one treatment characteristic, the at least one treatment characteristic including at least one target-related tissue ancestry-correlated binding site, comprises:
means for providing at least one differentially-expressed protein or peptide or glycopeptide or lipopeptide associated with endothelial tissue as the at least one target-related tissue ancestry-correlated binding site.

34. The treatment system of claim 1 wherein the means for providing at least two instances of at least one treatment characteristic, the at least one treatment characteristic including at least one target-related tissue ancestry-correlated binding site, comprises:
means for providing at least integrin avB3 as the at least one target-related tissue ancestry-correlated binding site.

35. The treatment system of claim 1 wherein the means for providing at least two instances of at least one treatment characteristic, the at least one treatment characteristic including at least one target-related tissue ancestry-correlated binding site, comprises:
means for providing at least an antigen as the at least one target-related tissue ancestry-correlated binding site.

36. The treatment system of claim 1 wherein the means for providing at least two instances of at least one treatment characteristic, the at least one treatment characteristic including at least one target-related tissue ancestry-correlated binding site, comprises:
means for providing at least a tissue factor as the at least one target-related tissue ancestry-correlated binding site.

37. The treatment system of claim 1 wherein the means for providing at least two instances of at least one treatment characteristic, the at least one treatment characteristic including at least one target-related tissue ancestry-correlated binding site, comprises:
means for providing the at least two instances of the at least one treatment characteristic from at least one relational database.

38. The treatment system of claim 1 wherein the means for providing at least two instances of at least one treatment characteristic, the at least one treatment characteristic including at least one target-related tissue ancestry-correlated binding site, comprises:
means for providing the at least two instances of the at least one treatment characteristic from at least one object-oriented database.

39-48. (canceled)

49. A treatment system comprising: the means for accepting an identification of at least one instance of at least one treatment parameter,
the at least one treatment parameter including at least one target-related tissue ancestry-correlated binding site, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor; and
means for providing at least two instances of at least one treatment characteristic,
the at least one treatment characteristic including at least one target-related tissue ancestry-correlated binding agent.

50. The treatment system of claim 49 wherein the means for accepting an identification of at least one instance of at least one treatment parameter, the at least one treatment parameter including at least one target-related tissue ancestry-correlated binding site, comprises:
means for accepting at least one protein or peptide or glycopeptide or lipopeptide induced or expressed at or about a tissue-vasculature interface or circulatory endothelium as the at least one target-related tissue ancestry-correlated binding site.

51. The treatment system of claim 49 wherein the means for accepting an identification of at least one instance of at least one treatment parameter, the at least one treatment parameter including at least one target-related tissue ancestry-correlated binding site, comprises:
means for accepting at least one peptide or glycopeptide or lipopeptide as the at least one target-related tissue ancestry-correlated binding site.

52. The treatment system of claim 49 wherein the means for accepting an identification of at least one instance of at least one treatment parameter, the at least one treatment parameter including at least one target-related tissue ancestry-correlated binding site, comprises:
means for accepting at least an aminopeptidase P (APP) protein as the at least one target-related tissue ancestry-correlated binding site.

53. The treatment system of claim 49 wherein the means for accepting an identification of at least one instance of at least one treatment parameter, the at least one treatment parameter including at least one target-related tissue ancestry-correlated binding site, comprises:
means for accepting at least one differentially-expressed protein or peptide or glycopeptide or lipopeptide associated with endothelial tissue as the at least one target-related tissue ancestry-correlated binding site.

54. The treatment system of claim 49 wherein the means for accepting an identification of at least one instance of at least one treatment parameter, the at least one treatment parameter including at least one target-related tissue ancestry-correlated binding site, comprises:
means for accepting at least integrin avB3 as the at least one target-related tissue ancestry-correlated binding site.

55. The treatment system of claim 49 wherein the means for accepting an identification of at least one instance of at least one treatment parameter, the at least one treatment parameter including at least one target-related tissue ancestry-correlated binding site, comprises:
means for accepting at least an antigen as the at least one target-related tissue ancestry-correlated binding site.

56. The treatment system of claim 49 wherein the means for accepting an identification of at least one instance of at least one treatment parameter, the at least one treatment parameter including at least one target-related tissue ancestry-correlated binding site, comprises:
means for at least a tissue factor as the at least one target-related tissue ancestry-correlated binding site.

57. The treatment system of claim 49 wherein the means for providing at least two instances of at least one treatment characteristic, the at least one treatment characteristic including at least one target-related tissue ancestry-correlated binding agent, comprises:
means for providing at least an antibody as the at least one target-related tissue ancestry-correlated binding agent, the antibody associated with the at least one target-related tissue ancestry-correlated binding site.

58. (canceled)

59. The treatment system of claim 49 wherein the means for providing at least two instances of at least one treatment characteristic, the at least one treatment characteristic including at least one target-related tissue ancestry-correlated binding agent, comprises:
means for providing at least a peptide or glycopeptide or lipopeptide as the at least one target-related tissue ancestry-correlated binding agent, the peptide or glycopeptide or lipopeptide being associated with the at least one target-related tissue ancestry-correlated binding site.

60. The treatment system of claim 49 wherein the means for providing at least two instances of at least one treatment characteristic, the at least one treatment characteristic including at least one target-related tissue ancestry-correlated binding agent, comprises:
means for providing at least one ligand as the at least one target-related tissue ancestry-correlated binding agent, the at least one ligand associated with the at least one target-related tissue ancestry-correlated binding site.

61. A computer program product comprising:
a signal-bearing medium bearing
(a) one or more instructions for providing at least two instances of at least one treatment characteristic,
the at least one treatment characteristic including at least one target-related tissue ancestry-correlated binding agent; and
(b) one or more instructions for accepting an identification of at least one instance of at least one treatment parameter,
the at least one treatment parameter including at least one target-related tissue ancestry-correlated binding site, at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor.
